(19) United States
(12) Patent Application Publication
(10) Pub. No.: US 2024/0119269 A1
(43) Pub. Date: Apr. 11, 2024

(54) DYNAMIC SPARSITY-BASED ACCELERATION OF NEURAL NETWORKS

(71) Applicants: Arnab Raha, San Jose, CA (US); Dinakar Kondru, Frisco, TX (US); Deepak Abraham Mathaikutty, Chandler, AZ (US); Umer Iftikhar Cheema, Hillsboro, OR (US)

(72) Inventors: Arnab Raha, San Jose, CA (US); Dinakar Kondru, Frisco, TX (US); Deepak Abraham Mathaikutty, Chandler, AZ (US); Umer Iftikhar Cheema, Hillsboro, OR (US)

(21) Appl. No.: 18/543,356

(22) Filed: Dec. 18, 2023

(51) Int. Cl. G06N 3/048

(52) U.S. Cl. CPC G06N 3/048

(57) ABSTRACT

A deep neural network (DNN) accelerator may facilitate dynamic sparsity-based acceleration and operate in various sparsity modes including a combined sparsity mode, a weight sparsity mode, an activation sparsity mode, and a dense mode. The DNN accelerator may receive a configuration parameter indicating whether to accelerate the layer based on sparsity in a weight tensor of the layer. The configuration parameter may be generated offline, e.g., before the execution of the DNN is started. The DNN accelerator computes one or more activations of the layer in a previous layer in the DNN. The one or more activations are one or more elements of an activation tensor of the layer. The DNN accelerator may determine a sparsity mode for the layer based on the configuration parameter and sparsity in the activation tensor. One or more sparse cells in the DNN accelerator may execute the layer in the sparsity mode.

### TECHNICAL FIELD

This disclosure relates generally to neural networks (also referred to as “deep neural networks” or “DNN”), and more specifically, dynamic sparsity-based acceleration of DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 is a block diagram of a DNN module, in accordance with various embodiments.

FIG. 5 illustrates an example load module capable of operating in various sparsity modes, in accordance with various embodiments.

FIG. 6 illustrates a densification process, in accordance with various embodiments.

FIG. 7 illustrates readers in an example load module, in accordance with various embodiments.

FIG. 8 illustrates a sparse cell in a combined sparsity mode, in accordance with various embodiments.

FIG. 9 illustrates the sparse cell in a one-sided sparsity mode, in accordance with various embodiments.

FIG. 10 illustrates the sparse cell in a dense mode, in accordance with various embodiments.

FIG. 11 illustrates an example sparse cell array, in accordance with various embodiments.

FIG. 12 illustrates configurable read ports in a sparse cell, in accordance with various embodiments.

FIG. 13 illustrates sparsity-based MAC operation, in accordance with various embodiments.

FIG. 14 illustrates an example drain module, in accordance with various embodiments.

FIG. 15 illustrates an example data draining path, in accordance with various embodiments.

FIG. 16 illustrates an example sparsity encoder, in accordance with various embodiments.

FIG. 17 is a flowchart showing a method of selecting sparsity mode for DNN layers, in accordance with various embodiments.

FIG. 18 is a flowchart showing a method of accelerating DNN layer, in accordance with various embodiments.

FIG. 19 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations (also referred to as “neural network operations”), such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

The fundamental operation of a convolution is MAC operations between input activations and kernel weights. Convolutions exhibit sparsity in the form of input activations and weights, as many of these data elements can have zero values. These zeros do not contribute to the accumulation of partial sums during the MAC operations. Nonlinear activation functions, such as rectified linear activation function (ReLU), can be present as post processing operations of convolution and can lead to sparsity in activations of subsequent layers. As ReLU typically clamps all negative value to zero, it can result in a significant number of zeros being present in the output activations, which are input activations of subsequent layers. Such sparsity-introducing activation functions is the main source of activation sparsity. On the weight side, sparsity may be introduced post training by pruning small magnitude values and replacing them with zero. During training, sparsity can be introduced by employing techniques such as certain types of regularization to encourage weight values to zero.

Leveraging sparsity in DNN accelerators can be crucial for achieving efficient and scalable AI systems. By taking advantage of sparsity, DNN accelerators can reduce the amount of computation and memory accesses required for a given task, leading to faster and more energy-efficient execution of DNNs. Sparsity can also enable the deployment of larger models with higher accuracy without requiring more expensive hardware. There are a number of sparse neural network accelerator (NNA) architectures. A sparse NNA typically needs to read in both the data and control information where the control is used to indicate where the nonzero data elements are located. Of the various sparse architectures, different architecture use different control formats to represent the sparse data, such as run-length-encoded streams, coordinate lists, or bit masks of nonzero entries.

A bit mask of nonzero entries may also be referred to as a sparsity map or a sparsity vector. Weight sparsity vectors can be generated offline, e.g., before a DNN execution process is started, and stored in memory. A DNN execution process may include inputting data into the DNN, executing deep learning operations in the DNN, and generating an output of the DNN. A DNN execution process may be used for DNN training or inference of a trained DNN. Activation sparsity vectors can be generated at run time (e.g., during a DNN execution process) and written to memory by the NNA. The sparsity vectors may contain a bit entry for every element in the weight tensor or activation tensor. The weight tensor or activation tensor written to memory may be compressed by removing the zeros in the weight tensor or activation tensor. The compressed format of a weight tensor or activation tensor may be referred to as “compressed data,” “sparse data,” or “packed data,” versus the uncompressed format of a weight tensor or activation tensor (i.e., no data elements are removed) may be referred to as “dense data.” This sparsity approach has several benefits. First, combining weight and activation sparsity to remove and skip redundant computation allows faster processing of layers, reduced power consumption and provides sparse acceleration. The packing of data written to memory with the removal of zeros, not only reduces the cost of data movement as well as the bandwidth requirement for reading in weights and activations, but also results in a smaller storage requirement.

Currently available DNN accelerators can leverage the underlying sparsity in activations and weights to accelerate the DNN computation. Some DNN accelerators can use fixed one-sided sparsity either in the weight or activation side. Some DNN accelerators can use two-sided combined sparsity and can achieve higher acceleration due to the skipping of zeros in both activations and weights, but that comes at the cost of higher area or power overheads compared to fixed one-sided sparsity. While in general, sparsity improves bandwidth overall, the reading of the control vector, with a bit per byte of activations/weights, means that there is an overhead to reading in the control information as well as the data when compared to a fully dense architecture.

Many recently developed deep learning models (e.g., transformers, etc.) have moved on from ReLU-based activation functions. Some models may not be trained for sparsity (or structured sparsity) but can be trained for sparsity, subsequently perform “thinning” of the model resulting in a leaner/smaller model having a smaller number of nonzero input channels and output channels per DNN layer. DNN accelerators that can exploit unstructured sparsity for achieving high eTOPS/mm2 and eTOPS/W could perform a wider MAC operation in the channel dimension potentially resulting in lesser opportunities for compute acceleration. In addition, this can reduce the additional compute acceleration that can be achieved from two-sided (i.e., both weight and activation) sparsity compared to the acceleration achieved from one-sided (i.e., either weight or activation) sparsity separately.

Embodiments of the present disclosure may improve on at least some of the challenges and issues described above by providing dynamic sparsity-based acceleration of DNNs. An example DNN accelerator in the present disclosure can facilitate dynamic sparsity-based acceleration. For instance, the DNN accelerator can operate in various sparsity modes. The sparsity modes may include a combined sparsity mode (also referred to as “two-sided sparsity mode”) in which a layer can be accelerated based on both weight sparsity and activation sparsity, one-sided sparsity mode (e.g., a weight sparsity mode or an activation sparsity mode) in which a layer can be accelerated based on either weight sparsity or activation sparsity, and a dense mode in which a layer is not accelerated based on sparsity. The sparsity mode of the DNN accelerator may be dynamically changed, e.g., for different layers in the DNN. In an example where a group of layers are selected for dynamic sparsity-based acceleration, the DNN accelerator may switch from the combined sparsity mode to the weight sparsity mode after the first layer is executed to execute at least part of the second layer. The DNN accelerator may switch back to the combined sparsity mode or switch to the activation sparsity mode after the second layer is executed to execute at least part of the third layer. The DNN accelerate may switch to a different mode after the third layer is executed to execute at least part of the fourth layer. This dynamic acceleration process may continue till all the selected layers or all layers in the DNN are executed.

In various embodiments of the present disclosure, a DNN accelerator may receive a configuration parameter for a layer. The configuration parameter may indicate whether to accelerate the layer based on sparsity in a weight tensor of the layer. The configuration parameter may be generated offline, e.g., before the execution of the DNN is started. The configuration parameter may be generated based on sparsity in a weight tensor of the layer. The weight tensor may be determined through training the DNN. In the process of executing the DNN, the DNN accelerator may compute one or more activations of the layer in a previous layer in the DNN. The previous layer may be arranged before the layer in the DNN. The one or more activations are one or more elements of an activation tensor of the layer. The activation tensor may be the input tensor (or part of the input tensor) of the layer or the output tensor (or part of the output tensor) of the previous layer. The DNN accelerator may determine an activation sparsity score of the layer. The activation sparsity score indicates a measurement of sparsity in the activation tensor. The DNN accelerator may determine a sparsity mode for the layer based on the configuration parameter and the activation sparsity score. The DNN accelerator may also estimate energy (e.g., power, etc.) consumption for executing the layer in different sparsity modes and select a sparsity mode based on the estimated energy consumption, the configuration parameter, and the activation sparsity score. After the sparsity mode for the layer is selected, one or more sparse cells in the DNN accelerator may perform one or more MAC operations of the layer in the sparsity mode.

Compared with currently available sparsity acceleration technologies, dynamic sparsity acceleration in the present disclosure can provide a balance between performance and power consumption by leveraging the underlying sparsity in a dynamic, intelligent, and efficient manner. It can enable high performance and energy-efficient compute for running AI workloads even with client and edge AI devices that usually have more weightage to performance per Watt (TOPS/W) and performance per area (TOPS/mm2) compared to raw peak performance (pTOPS) due to their small form factor where power and area can come at a premium.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

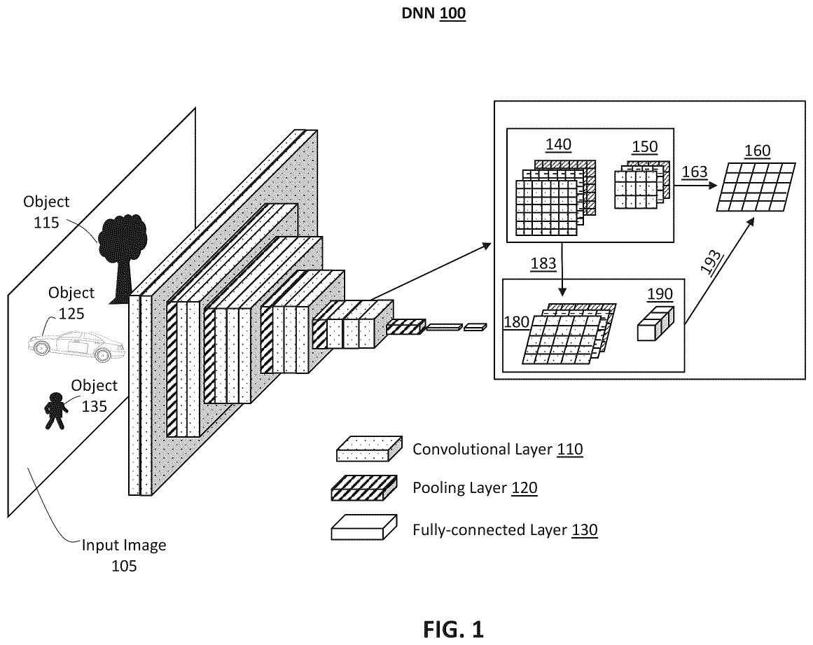

FIG. 1 illustrates an example DNN 100, in accordance with various embodiments. The DNN 100 may be an example of a teacher network or an example of a student network. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully-connected layers 130 (individually referred to as “fully-connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generate a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully-connected layers 130 are the last layers of the DNN. The fully-connected layers 130 may be convolutional or not. The fully-connected layers 130 receive an input operand. The input operand defines the output of the convolutional layers 110 and pooling layers 120 and includes the values of the last feature map generated by the last pooling layer 120 in the sequence. The fully-connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully-connected layer 130 by using a logistic function (binary classification) or a SoftMax function (multi-class classification) as an activation function.

In some embodiments, the fully-connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully-connected layers 130 multiply each input element by weight, make the sum, and then apply an activation function (e.g., logistic if N=2, SoftMax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

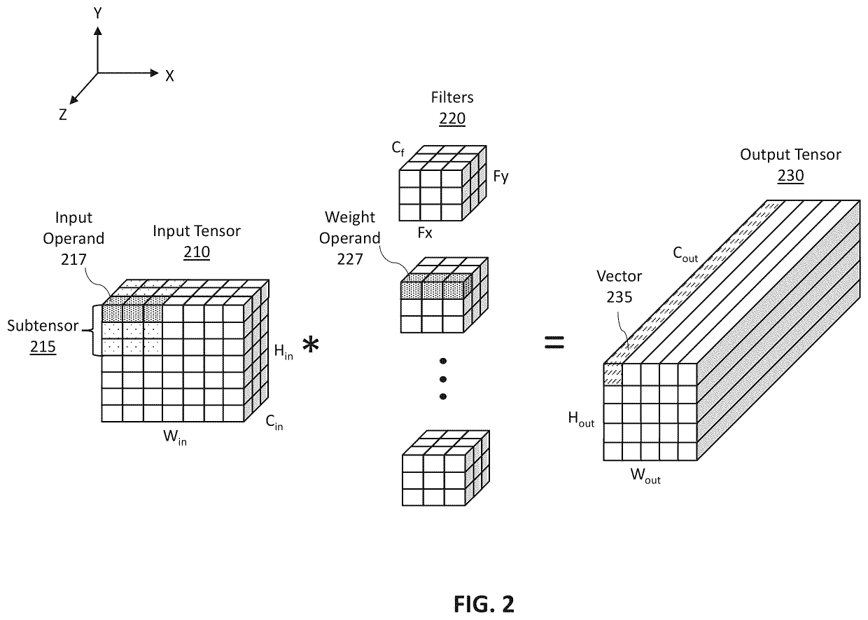

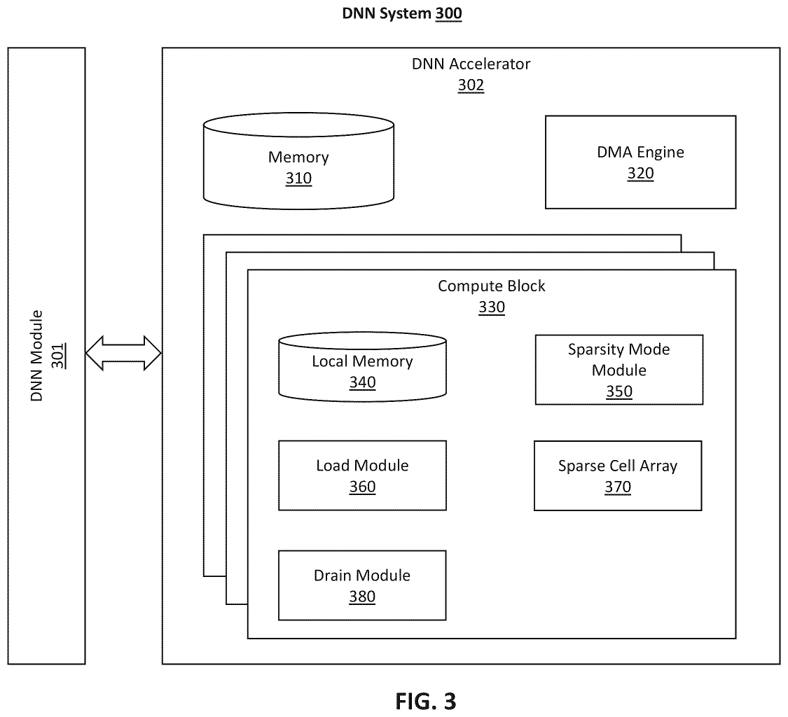

FIG. 2 illustrates an example convolution, in accordance with various embodiments. The convolution may be a deep learning operation in a convolutional layer of a DNN, e.g., a convolutional layer 110 in FIG. 1. The convolution can be executed on an input tensor 210 and filters 220 (individually referred to as “filter 220”). The result of the convolution is an output tensor 230. In some embodiments, the convolution is performed by a DNN accelerator. An example of the DNN accelerator may be the DNN accelerator 302 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Lᵢₙ×Cᵢₙ, where Hᵢₙ is the height of the 3D matrix (i.e., the length along the Y axis, which indicates the number of activations in a column in the 3D matrix of each input channel), Win is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and Cr is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 2×3×3, i.e., the filter 220 includes 2 convolutional kernels with a spatial size of 2×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wot may depend on the heights and weights of the input tensor 210 and each filter 220.

As a part of the convolution, MAC operations can be performed on a 2×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (X, Y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 2×3×3 subtensor (e.g., the subtensor 215) and a filter 220 may be performed by a plurality of MAC units. One or more PEs may receive an input operand (e.g., an input operand 217 shown in FIG. 2) and a weight operand (e.g., the weight operand 227 shown in FIG. 2). The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a MAC unit. The MAC unit may receive an activation and a weight (“an activation-weight pair”) at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 230 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 210 may be results of post processing of the previous DNN layer.

Example DNN System

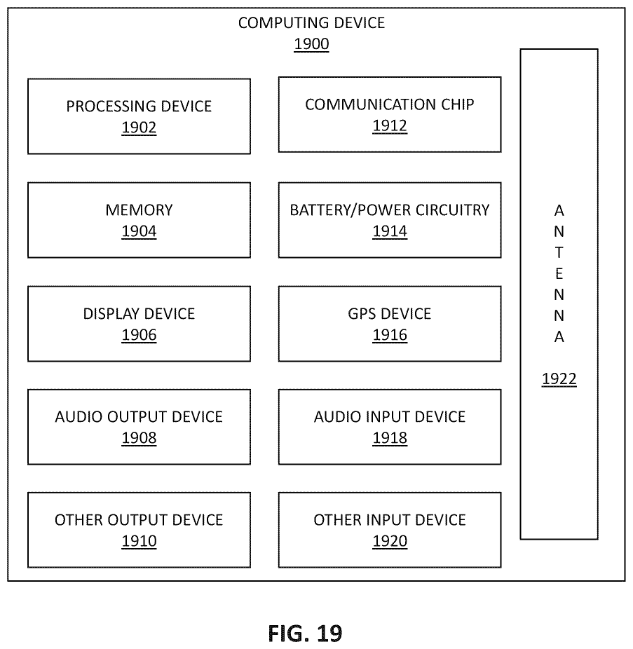

FIG. 3 is a block diagram of a DNN system 300, in accordance with various embodiments. The whole DNN system 300 or a part of the DNN system 300 may be implemented in one or more computing devices, such as the computing device 1900 in FIG. 19. The DNN system 300 can generate and execute DNNs, such as the DNN 100 in FIG. 1. As shown in FIG. 3, the DNN system 300 includes a DNN module 301 and a DNN accelerator 302. In other embodiments, alternative configurations, different or additional components may be included in the DNN system 300. For instance, the DNN system 300 may include multiple DNN modules or multiple DNN accelerators. Further, functionality attributed to a component of the DNN system 300 may be accomplished by a different component included in the DNN system 300 or a different system. In some embodiments, the DNN module 301 and DNN accelerator 302 may include different types of processing units. The DNN module 301 and DNN accelerator 302 may be implemented in the same chip or separate chips.

The DNN module 301 facilitates generation and deployment of DNNs. In some embodiments, the DNN module 301 may generate and train DNNs. For instance, the DNN module 301 can define the layered architecture of a DNN. The DNN module 301 can also determine the internal parameters of the DNN through a DNN training process. The DNN module 301 may also determine one or more hyperparameters that define how the DNN is trained. An example hyperparameter is a sparsity ratio that defines the sparsity level of one or more deep learning tensors for the DNN.

The DNN module 301 may also compress DNNs, e.g., during or after training. In some embodiments, the DNN module 301 may prune weights in one or more layers of a DNN by changing nonzero valued weight to zeros. The DNN module 301 may prune weights based on a target weight sparsity ratio. A weight sparsity ratio may be the ratio of the number of zero-valued weights to the total number of weights. In an example where the DNN module 301 prunes weight during DNN training, the DNN module 301 may prune weight of a layer to achieve a target sparsity ratio after one or more epochs. The DNN module 301 may prevent the pruned weights from changing values during the rest of the training process. Alternatively, the DNN module 301 may allow the pruned weights to change values so that a pruned, zero-valued weight may have a nonzero value after further training. The DNN module 301 may prune weights of the layer again after one or more additional epochs.

The DNN module 301 may deploy trained, compressed, or validated DNNs for use in deep learning applications. The DNN module 301 may control execution processes of trained, compressed, or validated DNNs. For instance, the DNN module 301 may configure one or more sparsity modes of the DNN accelerator 302 that performs execution of a DNN. In some embodiments, the DNN module 301 may determine sparsity modes of the DNN accelerator 302 on a layer-basis. For instance, the DNN module 301 may determine whether to activate weight sparsity-based acceleration for a DNN layer based on the weight tensor of the DNN layer or not. The DNN module 301 may generate a configuration parameter, the value of which indicates the determination. The DNN module 301 may provide the configuration parameter to the DNN accelerator 302. The DNN accelerator 302 may execute the DNN layer in accordance with the configuration parameter. The DNN module 301 may determine to activate weight sparsity-based acceleration for one layer in a DNN but determine not to activate weight sparsity-based acceleration for another layer in the DNN.

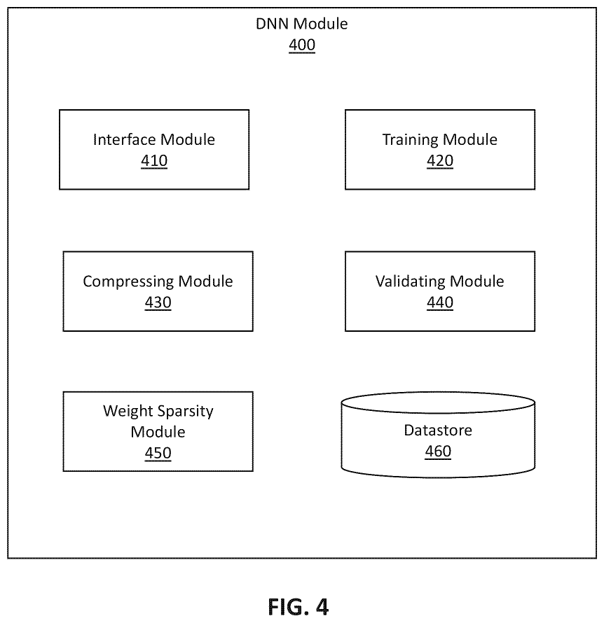

In some embodiments, the DNN module 301 may distribute trained, compressed, or validated DNNs to devices or systems which may use the DNNs to perform tasks (e.g., image classification, motion planning, etc.) for which the DNNs were trained. In other embodiments, the DNN module 301 may facilitate deployment of the DNNs using the DNN accelerator 302. For instance, the DNN module 301 may receive data from a device or system coupled with the DNN system 300 and input the received data (or data generated by the DNN module 301, e.g., based on the received data) into a DNN. The DNN module 301 may generate instructions (e.g., configuration files) that control the operation of the DNN accelerator 302 during the DNN execution. The DNN module 301 may receive an output of the DNN from the DNN accelerator 302. The DNN module 301 may transmit the output of the DNN (or a result of processing the output of the DNN by the DNN module 301) to the device or system. Certain aspects of the DNN module 301 are provided below in conjunction with FIG. 4.

The DNN accelerator 302 executes DNNs provided by the DNN module 301. For instance, the DNN accelerator 302 can perform DNN execution, e.g., by running deep learning operations in the DNNs, for training DNNs or for using the trained/compressed/validated DNNs to perform tasks. As shown in FIG. 3, the DNN accelerator 302 includes a memory 310, a DMA (direct memory access) engine 320, and compute blocks 330 (individually referred to as “compute block 330”). In other embodiments, alternative configurations, different or additional components may be included in the DNN accelerator 302. For example, the DNN accelerator 302 may include more than one memory 310 or DMA engine 320. As another example, the DNN accelerator 302 may include a single compute block 330. Further, functionality attributed to a component of the DNN accelerator 302 may be accomplished by a different component included in the DNN accelerator 302 or by a different system. A component of the DNN accelerator 302 may be implemented in hardware, software, firmware, or some combination thereof.

The memory 310 stores data associated with deep learning operations performed by the DNN accelerator. In some embodiments, the memory 310 may store data to be used by the compute blocks 330 for DNN execution. For example, the memory 310 may store weights, such as weights of convolutional layers, which are determined by training DNNs. As another example, the memory 310 may store inputs to DNNs or outputs of DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 302. In some embodiments, the memory 310 includes one or more dynamic random-access memories (DRAMs).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may execute a DNN layer by running one or more deep learning operations in the DNN layer. A compute block 330 may execute a layer, or a portion of a layer, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330. A compute block 330 may also be referred to as a compute tile. In some embodiments, each compute block 330 may be a processing unit.

In the embodiments of FIG. 3, each compute block 330 includes a local memory 340, a sparsity mode module 350, a load module 360, a sparse cell array 370, and a drain module 380. Some or all the components of the compute block 330 can be implemented on the same chip. In other embodiments, alternative configurations, different or additional components may be included in the compute block 330. Further, functionality attributed to a component of the compute block 330 may be accomplished by a different component included in the compute block 330, a different compute block 330, another component of the DNN accelerator 302, or a different system. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. Data in the local memory 340 may be transferred to or from the memory 310, e.g., through the DMA engine 320. In some embodiments, data in the local memory 340 may be transferred to or from the local memory of another compute block 330. The local memory 340 may store data received, used, or generated by the sparsity mode module 350, the load module 360, the sparse cell array 370, or the drain module 380. Examples of the data may include input activations, weights, output activations, sparsity bitmaps, and so on.

In some embodiments, the local memory 340 may store dense tensors (e.g., dense activation tensors, dense weight tensors, etc.), sparse tensors (e.g., sparse activation tensors, sparse weight tensors, etc.), and so on. A dense tensor may be a tensor from which zero-valued elements (if any) are not removed. A dense tensor may be converted to a sparse tensor by removing one or more zero-valued elements in the dense tensor. A sparse tensor may also be referred to as a compressed tensor or packed tensor. The process of converting a dense tensor to a sparse tensor may be referred to as sparsity encoding. Sparsity encoding may also generate a sparsity tensor. Each element in the sparsity tensor may correspond to a different element in the dense tensor and indicate whether the element in the dense tensor is zero or not. The sparsity tensor may indicate positions of elements of the sparse tensor in the dense tensor. The sparsity tensor may be a sparsity bitmap, each element of which is a bit. A sparse tensor may be converted to a dense tensor through a densifying process, in which one or more zeros may be added to the sparse tensor based on the sparsity tensor.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 356, 512, 1024, 3048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The sparsity mode module 350 determines sparsity modes in which the compute block 330 operates to execute DNN layers. For instance, the sparsity mode module 350 may determine whether to accelerate a layer based on weight sparsity or activation sparsity. The sparsity mode module 350 select the sparsity mode for a layer from a group of sparsity modes that includes, for example, combined sparsity mode in which the layer is accelerated based on both weight sparsity and activation sparsity, activation sparsity mode in which the layer is accelerated based on activation sparsity but not based on weight sparsity, weight sparsity mode in which the layer is accelerated based on weight sparsity but not based on activation sparsity, and a dense mode in which the layer is not accelerated based on sparsity. In some embodiments (e.g., embodiments where a layer is executed by multiple compute blocks 330), the sparsity module 345 may determine the sparsity mode for all the compute blocks 330 that executes the layer.

To determine a sparsity mode for a layer, the sparsity mode module 350 may estimate energy (e.g., power) consumption of the compute block 330 executing the layer in various sparsity modes. For instance, the sparsity mode module 350 may estimate the energy consumption for executing the layer in the combined sparsity mode, the energy consumption for executing the layer in the weight sparsity mode, the energy consumption for executing the layer in the activation sparsity mode, and the energy consumption for executing the layer in the dense mode. The sparsity mode module 350 may also measure sparsity in the activation tensor of the layer. The activation tensor may be the input tensor (or part of the input tensor) of the layer. The activation tensor may be computed in the previous layer and may be output from the compute block 330 by the drain module 380. The sparsity mode module 350 may determine the amount of sparsity in the activation tensor using sparsity counters in the drain module 380. In some embodiments, the sparsity mode module 350 may determine an activation sparsity score that indicates the measurement of sparsity in the activation tensor. The sparsity mode module 350 may further measure combined sparsity of the layer. For instance, the sparsity mode module 350 may measure sparsity in the output tensor of the layer based on the weight tensor and the activation tensor. The sparsity mode module 350 may determine a combined sparsity score indicates the measurement of sparsity in the output tensor.

In some embodiments, the sparsity mode module 350 may receive configuration parameters from the DNN module 301. A configuration parameter may correspond to a layer and indicate whether to accelerate the layer based on weight sparsity. The sparsity mode module 350 may determine the sparsity mode of the layer based on the configuration parameter. In an example where the configuration parameter of a layer indicates to accelerate the layer based on weight sparsity, the sparsity mode module 350 may determine whether to further accelerate the layer based on a measurement of sparsity in the activation tensor of the layer. The sparsity mode module 350 may further determine whether the combined sparsity score is greater than a first threshold score. The first threshold score may indicate a difference between estimated energy consumption of executing the layer with combined sparsity acceleration (i.e., executing the layer in the combined sparsity mode) and estimated energy consumption of executing the layer with weight sparsity acceleration but without activation sparsity acceleration (i.e., executing the layer in the weight sparsity mode). In some embodiments, the first threshold score is a ratio of the estimated energy consumption of executing the layer with combined sparsity acceleration to the estimated energy consumption of executing the layer with weight sparsity acceleration.

When the combined sparsity score is greater than the first threshold score, the sparsity mode module 350 may select the combined sparsity mode as the sparsity mode for the layer. When the combined sparsity score is not greater than the first threshold score, the sparsity mode module 350 may select either the weight sparsity mode or the activation sparsity mode as the sparsity mode for the layer. For instance, the sparsity mode module 350 may compare the activation sparsity score with a weight sparsity score. The weight sparsity score may be determined by the DNN module 301 and may indicate a measurement of sparsity in the weight tensor of the layer. When the activation sparsity score is greater than the weight sparsity score, the sparsity mode module 350 may select the activation sparsity mode as the sparsity mode for the layer. When the activation sparsity score is not greater than the weight sparsity score, the sparsity mode module 350 may select the weight sparsity mode as the sparsity mode for the layer.

In an example where the configuration parameter indicates not to accelerate the layer based on weight sparsity, the sparsity mode module 350 may determine whether the activation sparsity score is greater than a second threshold score that indicate a difference between estimated energy consumption of executing the layer with activation sparsity acceleration (i.e., executing the layer in the activation sparsity mode) and estimated energy consumption of executing the layer with no sparsity acceleration (i.e., executing the layer in the dense mode). The second threshold score may be a ratio of the estimated energy consumption of executing the layer with activation sparsity acceleration to the estimated energy consumption of executing the layer with no sparsity acceleration. When the activation sparsity score is greater than the second threshold score, the sparsity mode module 350 may determine whether the combined sparsity score is greater than the first threshold score. The sparsity mode module 350 selects the combined sparsity mode when combined sparsity score is greater than the first threshold score. Otherwise, the sparsity mode module 350 selects the activation sparsity mode. When the activation sparsity score is not greater than the second threshold score, the sparsity mode module 350 selects the dense mode.

The load module 360 loads data from the local memory 340 to the sparse cell array 370. The load module 360 may read tensors from the local memory 340. The tensors may include sparse activation tensors, sparse weight tensors, activation sparsity tensors, weight sparsity tensors, and so on. In some embodiments, the load module 360 may load data based on the sparsity mode determined by the sparsity mode module 350. The load module 360 may select different data to transmit to the sparse cell array 370 in different sparsity modes. For instance, the load module 360 may transmit an activation sparsity tensor and a weight sparsity tensor of a layer to the sparse cell array 370 in the combined sparsity mode, while transmit the activation sparsity tensor but not the weight sparsity tensor to the sparse cell array 370 in the activation sparsity mode and transmit the weight sparsity tensor but not the activation sparsity tensor to the sparse cell array 370 in the weight sparsity mode. In the dense mode, the load module 360 does not transmit either the activation sparsity tensor or the weight sparsity tensor to the sparse cell array 370.

In some embodiments, the load module 360 may process (e.g., densify) data stored in the local memory 340 before providing the data to the sparse cell array 370. In an example, the load module 360, while operating in the weight sparsity mode, may densify sparse activation tensors to generate dense activation tensors based on corresponding activation sparsity tensors. For instance, the load module 360 may add one or more zeros into a sparse activation tensor based on an activation sparsity tensor associated with the sparse activation tensor to generate the dense activation tensor. The dense activation tensor includes one or more elements than the sparse activation tensor. The additional element(s) are zero valued. The load module 360 may identify one or more elements in the activation sparsity tensor that correspond to the zero-valued element(s), determine the position of each of the zero-valued element(s) in the dense activation tensor, and insert the zero-valued element(s) into the sparse activation tensor based on the determined positions. After the densification, the load module 360 may transmit the dense activation tensors to the sparse cell array 370. The load module 360 may also transmit corresponding sparse weight tensors and weight sparsity tensors to the sparse cell array 370. Activation sparsity tensor of the dense activation tensors may not be loaded to the sparse cell array 370.

In another example, the load module 360, while operating in the activation sparsity mode, may densify sparse weight tensors to generate dense weight tensors based on corresponding weight sparsity tensors by inserting zeros into sparse weight tensors. The densification of sparse weight tensors may be similar to the densification of sparse activation tensors described above. After the densification, the load module 360 may transmit the dense weight tensors to the sparse cell array 370. The load module 360 may also transmit corresponding sparse activation tensors and activation sparsity tensors to the sparse cell array 370. Weight sparsity tensor of the dense weight tensors may not be loaded to the sparse cell array 370.

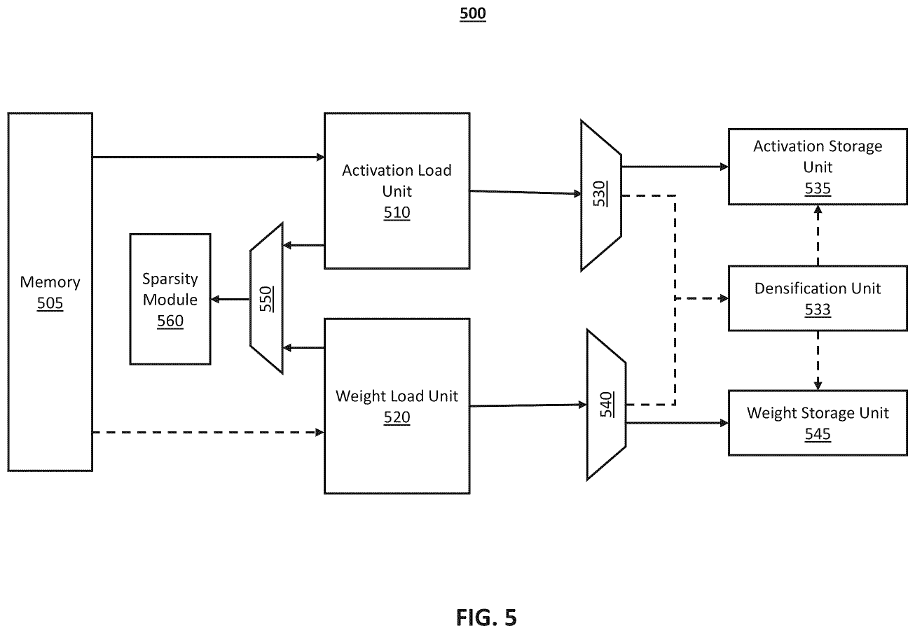

In yet another example, the load module 360, while operating in the dense mode, may densify both sparse weight tensors and sparse activation tensors. The load module 360 may generate the input tensor and weight tensor of the layer and transmit the tensors to the sparse cell array 370 for executing the layer without sparsity acceleration. Certain aspects of the load module 360 are described below in conjunction with FIGS. 5-7.

The sparse cell array 370 may include sparse cells arranged in columns, or columns and rows. Each sparse cell may include an array of MAC units that can perform MAC operations. In some embodiments (e.g., embodiments where the compute block 330 executes a convolutional layer), a computation in an MAC unit may be an MAC operation on an activation operand and a weight operand. The activation operand may be an activation tensor that may include one or more activations in the input tensor of the convolution. Different activations may be in different input channels. The weight operand may be a weight tensor that may include one or more weights in the filter of the convolution. The values of the weights are determined through training the DNN. The weights in the weight operand may be in different input channels.

In some embodiments, an MAC unit includes one or more multipliers for performing multiplications. An MAC unit may also include one or more accumulators (“adders”) for performing accumulations. A column of MAC units is referred to as an MAC column. An MAC column may be associated with one or more MAC lanes. An MAC lane is a path for loading data e.g., by the load module 360, into an MAC column. An MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, the sparse cell array 370 may be capable of depthwise convolution, standard convolution, or both. In a depthwise convolution, an MAC unit may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the MAC unit. The sparse cell array 370 may output multiple output operands at a time, each of which is generated by a different MAC unit. In a standard convolution, MAC operations may include accumulations across the channels. For instance, as opposed to generating an output operand, a MAC unit may accumulate products across different channels to generate a single output point.

In some embodiments, the sparse cell array 370 may perform MAC operations in quantized deep learning operations, such as MAC operations in a quantized convolution. In some embodiments, an MAC unit in the sparse cell array 370 may receive quantized activation and quantized weights and compute a quantized MAC result. The quantized MAC result may be a quantized value in an integer format and may be the output of the PE. In some embodiments, the MAC unit may also include a quantization multiplier that can multiply a quantization scale with the quantized MAC result, and the output of the MAC unit may be a real value in a floating-point format. The MAC unit may include no quantization subtractors as zero-point offsetting is not needed for the MAC operations in quantized deep learning operations.

In some embodiments, the sparse cell array 370 may include sparsity acceleration logic for facilitating sparsity acceleration. For instance, each sparse cell in the sparse cell array 370 may include one or more sparsity modules. In an example, each MAC column or each MAC row may have a corresponding sparsity module that accelerates MAC operations in the MAC column or MAC row. In some embodiments, a sparsity module accelerates computations in the sparse cell array 370 based on sparsity in activations, sparsity in weights, or both. The sparsity module may include a storage unit that stores a sparsity tensor, which may be loaded to the storage unit by the load module 360. The sparsity tensor may be an activation sparsity tensor, a weight sparsity tensor, or a combined sparsity tensor.

An activation sparsity tensor may be the sparsity tensor of an activation tensor and has the same number of elements as the activation tensor. An element in the activation sparsity tensor may indicate whether the corresponding element in the activation tensor is zero or not. For instance, a zero-valued in the activation sparsity tensor may indicate that the corresponding element in the activation tensor is zero. A one-valued in the activation sparsity tensor may indicate that the corresponding element in the activation tensor is nonzero. A weight sparsity tensor may be the sparsity tensor of a weight tensor and has the same number of elements as the weight tensor. An element in the weight sparsity tensor may indicate whether the corresponding element in the weight tensor is zero or not. For instance, a zero-valued in the weight sparsity tensor may indicate that the corresponding element in the weight tensor is zero. A one-valued in the weight sparsity tensor may indicate that the corresponding element in the weight tensor is nonzero. The sparsity module may generate a combined sparsity tensor using an activation sparsity tensor and a weight sparsity tensor. For instance, the sparsity module may multiply an element of the activation sparsity tensor with a corresponding element of the weight sparsity tensor to compute an element of the combined sparsity tensor. The positions of the three elements in their corresponding sparsity tensors may match. In some embodiments, each element in a sparsity tensor may be a bit, and the sparsity tensor may be referred to as a sparsity bitmap.

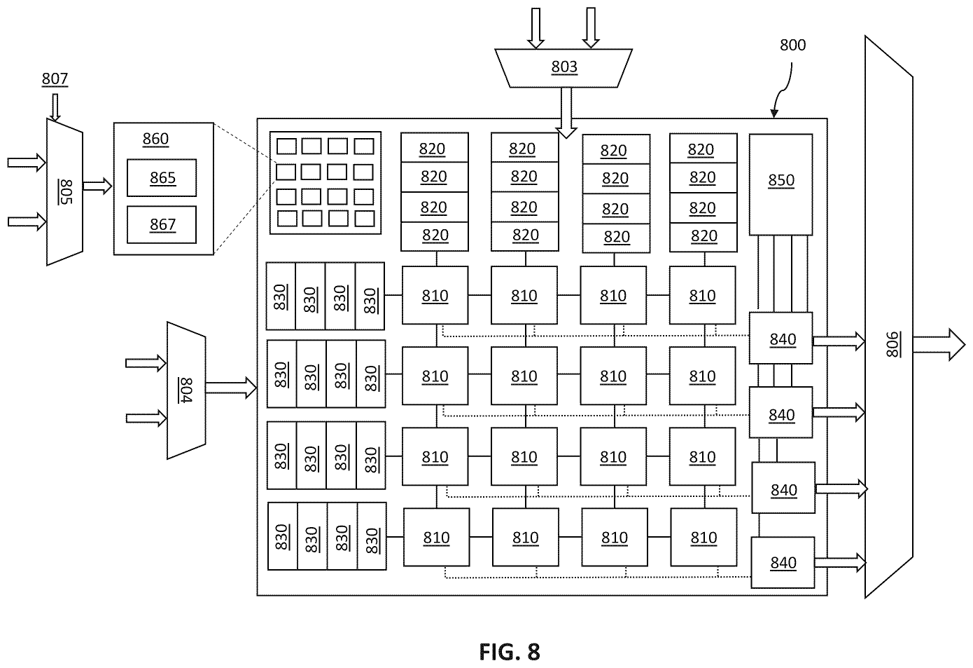

The sparsity module may use the sparsity tensor to identify activations and weights to be used in MAC operations by the MAC units. In an embodiment where the sparse cell array 370 operates in the combined sparsity mode, the sparsity module may identify activations and weights that correspond to nonzero valued elements of a combined sparsity tensor. In an embodiment where the sparse cell array 370 operates in the activation sparsity mode, the sparsity module may identify activations and weights that correspond to nonzero valued elements of an activation sparsity tensor. In an embodiment where the sparse cell array 370 operates in the weight sparsity mode, the sparsity module may identify activations and weights that correspond to nonzero valued elements of a weight sparsity tensor. The sparsity module may be bypassed in the dense mode as no sparsity acceleration would be conducted. Certain aspects of the sparse cell array 370 are provided below in conjunction with FIGS. 8-11.

The drain module 380 drains data from the sparse cell array 370 and writes the data to the local memory 340. The data may be outputs of MAC operations performed by MAC units in the sparse cell array 370. In some embodiments, the drain module 380 may drain data on a sparse cell level. For each sparse cell, the drain module 380 may drain outputs of MAC units in the sparse cell based on a row index or column index of each MAC unit. For instance, the drain module 380 may use a sequence of cycles to drain data from a sparse cell. The drain module 380 may drain the output of some of the MAC units in each cycle. The sequence of the cycles may be configured based on a configuration parameter indicating the operation mode of the load module 360.

In some embodiments, the drain module 380 may determine whether to drain the output of an MAC unit based on the column index of the MAC unit when the load module operates in the activation sparsity mode versus based on the row index of the MAC unit when the load module operates in the weight sparsity mode. For instance, for MAC operations where the load module 360 operates in the activation sparsity mode, the drain module 380 may drain the output of a different MAC column in each cycle. The sequence of cycles may start with the first MAC column (e.g., the MAC column on the left side of the sparse cell) and end with the last MAC column (e.g., the MAC column on the right side of the sparse cell). For MAC operations where the load module 360 operates in the weight sparsity mode, the drain module 380 may drain the output of a different MAC row in each cycle. The sequence of cycles may start with the first MAC row (e.g., the MAC row at the top of the sparse cell) and end with the last MAC row (e.g., the MAC column at the bottom of the sparse cell). In other embodiments, the drain module 380 may determine whether to drain the output of an MAC unit based on the row index of the MAC unit when the load module operates in the activation sparsity mode versus based on the column index of the MAC unit when the load module operates in the weight sparsity mode.

The drain module 380 may also include sparsity encoding logic that can convert outputs of the sparse cell array 370 from a dense format to a sparse format. For instance, the drain module 380 may be implemented with one or more sparsity encoders. A sparsity encoder converts dense data to compressed data based on sparsity in the dense data. For instance, the sparsity encoder may remove zeros in an activation tensor computed by the sparse cell array 370 to convert the activation tensor to a compressed activation tensor. The sparsity encoder may also generate sparsity tensors, including activation sparsity tensors.

In some embodiments, the data drained from the sparse cell array 370 may be at least part of an output tensor (e.g., the output tensor 230 in FIG. 2) of a deep learning operation. The sparsity encoder may generate a compressed version of the output tensor. The sparsity encoder may identify every zero-valued activation in the output tensor and remove these activations from the output tensor to generate a compressed activation tensor (aka “sparse activation tensor”). The sparsity encoder may also generate one or more sparsity tensors for the output tensor. A sparsity tensor may correspond to a portion of the output tensor (e.g., the vector 235 in FIG. 2). The sparsity tensor may include sparsity elements (e.g., bits), each of which corresponds to a different activation in the vector and indicates whether the corresponding activation is zeroed or not.

The drain module 380 may write the compressed activation tensor and the one or more sparsity tensors into the local memory 340. The sparse activation tensor and the one or more sparsity tensors may be further loaded to the memory 310, e.g., through the DMA engine 320. Additionally or alternatively, the sparse activation tensor and the one or more sparsity tensors may be loaded by the load module 360 to the sparse cell array for further computation, e.g., for performing a deep learning operation in the next layer.

FIG. 4 is a block diagram of a DNN module 400, in accordance with various embodiments. The DNN module 400 may be an embodiment of the DNN module 301 in FIG. 3. As shown in FIG. 4, the DNN module 400 includes an interface module 410, a training module 420, a compressing module 430, a validating module 440, a weight sparsity module 450, and a datastore 460. In other embodiments, alternative configurations, different or additional components may be included in the DNN module 400. Further, functionality attributed to a component of the DNN module 400 may be accomplished by a different component included in the DNN module 400 or a different module or system.

The interface module 410 facilitates communications of the DNN module 400 with other modules or systems. For example, the interface module 410 establishes communications between the DNN module 400 with an external database to receive data that can be used to train DNNs or input into DNNs to perform tasks. As another example, the interface module 410 supports the DNN module 400 to distribute DNNs to other systems, e.g., computing devices configured to apply DNNs to perform tasks.

The training module 420 trains DNNs by using a training dataset. The training module 420 forms the training dataset. In an embodiment where the training module 420 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 440 to validate performance of a trained DNN. The portion of the training dataset not including the tuning subset and the validation subset may be used to train the DNN.

The training module 420 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 420 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully-connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between two convolution layers. A fully-connected layer involves weights, biases, and neurons. It connects neurons in one layer to neurons in another layer. It is used to classify images between different categories by training.

In the process of defining the architecture of the DNN, the training module 420 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

After the training module 420 defines the architecture of the DNN, the training module 420 inputs a training dataset into the DNN. The training dataset includes a plurality of training samples. An example of a training sample includes an object in an image and a ground-truth label of the object. The training module 420 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 420 uses a cost function to minimize the error.

The training module 420 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 420 finishes the predetermined number of epochs, the training module 420 may stop updating the parameters in the DNN. The DNN having the updated parameters is referred to as a trained DNN.

The compressing module 430 compresses DNNs. For instance, the compressing module 430 may add pruning operations to DNN layers to reduce computational complexity or memory usage. A pruning operation may prune weight tensors of a DNN layer by changing one or more nonzero valued weights of the layer to zeros. The modification may be done before, during, or after training. Weights may be pruned during training, during inference, or a combination of both. The compressing module 430 may determine a sparsity ratio for a DNN layer. The sparsity ratio may be a ratio of the number of zero-valued weight to the total number of weights in the layer. The compressing module 430 may perform the pruning operation till the sparsity ratio of the DNN layer meets a target sparsity ration, such as 10%, 20%, 30%, 40%, 50%, and so on.

In some embodiments, the compressing module 430 may select one or more layers in a DNN and modify each selected layer with a pruning operation. For instance, the compressing module 430 may select computationally complex layers, such as layers with large filters. For a pruning operation of a layer or of a type of layer, the compressing module 430 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 430 may also measure energy saving, final DNN accuracy, or layer-wise sparsity caused by pruning operations.

After compressing a DNN, the compressing module 430 may fine tune the DNN, e.g., through a retraining process. The compressing module 430 may fine tunes DNNs after weights are pruned. In some embodiments, the fine-tuning process is a retraining or further training process. For instance, after weights in a DNN are pruned, the compressing module 430 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 430 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 430, the compressing module 430 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 4, 5, and so on.

The validating module 440 verifies accuracy of trained or compressed DNNs. In some embodiments, the validating module 440 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 440 may determine an accuracy score measuring the precision, recall, or a combination of precision and recall of the DNN. The validating module 440 may use the following metrics to determine the accuracy score: Precision=TP/(TP+FP) and Recall=TP/(TP+FN), where precision may be how many the DNN correctly predicted (TP or true positives) out of the total it predicted (TP+FP or false positives), and recall may be how many the DNN correctly predicted (TP) out of the total number of objects that did have the property in question (TP+FN or false negatives). The F-score (F-score=2*PR/(P+R)) unifies precision and recall into a single measure.

The validating module 440 may compare the accuracy score with a threshold score. In an example where the validating module 440 determines that the accuracy score of the DNN is less than the threshold score, the validating module 440 instructs the training module 420 to re-train the DNN. In one embodiment, the training module 420 may iteratively re-train the DNN until the occurrence of a stopping condition, such as the accuracy measurement indication that the DNN may be sufficiently accurate, or a number of training rounds having taken place.

The weight sparsity module 450 determines whether to activate weight sparsity acceleration in DNN layers. In some embodiments, the weight sparsity module 450 may select one or more layers in a DNN that can potentially be accelerated based on sparsity. The weight sparsity module 450 may select layers that processes data with sparsity. For instance, the weight sparsity module 450 may select convolution layers. Additionally or alternatively, the weight sparsity module 450 may select one or more layers that are arranged right after layers with deep learning operations that can introduce sparsity, such as activation functions that can introduce sparsity.

After a layer is selected, the weight sparsity module 450 may evaluate the amount of sparsity in a weight tensor of a layer. The weight tensor may be determined through training the DNN, e.g., by the training module 420. The weight tensor may be one or more filters, such as filters 220 in FIG. 2. The weight sparsity module 450 may determine a weight sparsity score of the layer. The weight sparsity score may indicate the estimated amount of sparsity in the weight tensor. In some embodiments, the weight sparsity module 450 may evaluate sparsity in weights offline, e.g., before DNN execution starts, as values of the weights can be known before execution.

The weight sparsity module 450 may compare the weight sparsity score with a threshold score. The weight sparsity module 450 may estimate energy consumption for executing the layer in the weight sparsity mode and energy consumption for executing the layer in the dense mode. The threshold score may indicate a difference between the two estimated energy consumptions. In some embodiments, the threshold score is a ratio of the estimated energy consumption for executing the layer in the weight sparsity mode to the estimated energy consumption for executing the layer in the dense mode. When the weight sparsity score is greater than the threshold score, the weight sparsity module 450 may determine to activate weight sparsity acceleration for the layer. When the weight sparsity score is not greater than the threshold score, the weight sparsity module 450 may determine not to activate weight sparsity acceleration for the layer. The weight sparsity module 450 may generate a configuration parameter that encodes its determination. For instance, the configuration parameter may indicate whether to accelerate the layer based on weight sparsity and provide the configuration parameter to the DNN accelerator 302 for executing the layer.

The datastore 460 stores data received, generated, used, or otherwise associated with the DNN module 400. For example, the datastore 460 stores the datasets used by the training module 420 and validating module 440. The datastore 460 may also store data generated by the training module 420 and validating module 440, such as the hyperparameters for training DNNs, internal parameters of trained DNNs (e.g., weights, etc.), data for sparsity acceleration (e.g., sparsity bitmap, etc.), and so on. The datastore 460 may store configuration parameters generated by the weight sparsity module 450. In the embodiment of FIG. 4, the datastore 460 is a component of the DNN module 400. In other embodiments, the datastore 460 may be external to the DNN module 400 and communicate with the DNN module 400 through a network.

FIG. 5 illustrates an example load module 500 capable of operating in various sparsity modes, in accordance with various embodiments. The load module 500 may be an example of the load module 360 in FIG. 3. In the embodiments of FIG. 5, the load module 500 includes an activation load unit 510, a weight load unit 520, three multiplexers (MUXs) 530, 540, and 550, and a densification unit 533. In other embodiments, the load module 500 may include fewer, more, or different components. For instance, the load module 500 may include data transfer paths, which may be connected to the activation load unit 510, weight load unit 520, MUXs 530, 540, and 550, or densification unit 533. In the embodiments of FIG. 5, the load module 500 is coupled to an activation storage unit 535 for storing activations, a weight storage unit 545 for storing weights, and a sparsity module 560.

The activation load unit 510 load activations and an activation sparsity tensor from a memory 505, as shown by the solid arrow between the memory 505 and the activation load unit 510. The weight load unit 520 loads weights and a weight sparsity tensor from the memory 505, as shown by the dash arrow between the memory 505 and the weight load unit 520. The memory 505 may be a local memory of a compute block, such as the local memory 340. The activations may be elements of an activation operand for one or more MAC operations. The weights may be elements of a weight operand for one or more MAC operations. The activation sparsity tensor may be a sparsity tensor of the activation operand, and the weight sparsity tensor may be a sparsity tensor of the weight operand. In some embodiments, the activations and weights are nonzero valued.

The activation load unit 510 transmits the activations and activation sparsity tensor to the MUX 530 and to the MUX 550, respectively. The activations are transmitted to and stored in the activation storage unit 535 through the MUX 530. The activation sparsity tensor is transmitted to and stored in the sparsity module 560 through the MUX 540. The weight load unit 520 transmits the weights and weight sparsity tensor to the MUX 540 and the MUX 550. The weights are transmitted to and stored in the weight storage unit 545 through the MUX 540. The weight sparsity tensor is transmitted to and stored in the sparsity module 560 through the MUX 540. The activation storage unit 535 or the weight storage unit 545 may include one or more register files.

In some embodiments (e.g., embodiments where the load module 500 operates in the combined sparsity mode), the densification unit 533 is bypassed. The activations may be transmitted directly from the MUX 530 to the activation storage unit 535, and the weights may be transmitted directly from the MUX 530 to the weight storage unit 545. In other embodiments, the densification unit 533 may process activations or weights before the data are stored in the activation storage unit 535 or the weight storage unit 545.

In some embodiments (e.g., embodiments where the load module 500 operates in the weight sparsity mode), the MUX 530 may transmit the activations and the activation sparsity tensor to the densification unit 533. The densification unit 533 may densify the activations using the activations parity tensor. For instance, the activations may be elements of a compressed activation tensor. The densification unit 533 may add one or more zeros into the compressed activation tensor to generate a dense activation tensor. The densification unit 533 may determine positions of the one or more zeros in the dense activation tensor based on the activation sparsity tensor. The densification unit 533 may send the dense activation tensor to the activation storage unit 535.

In some embodiments (e.g., embodiments where the load module 500 operates in the activation sparsity mode), the MUX 540 may transmit the weights and the weight sparsity tensor to the densification unit 533. The densification unit 533 may densify the weights using the weights parity tensor. For instance, the weights may be elements of a compressed weight tensor. The densification unit 533 may add one or more zeros into the compressed weight tensor to generate a dense weight tensor. The densification unit 533 may determine positions of the one or more zeros in the dense weight tensor based on the weight sparsity tensor. The densification unit 533 may send the dense weight tensor to the weight storage unit 545.

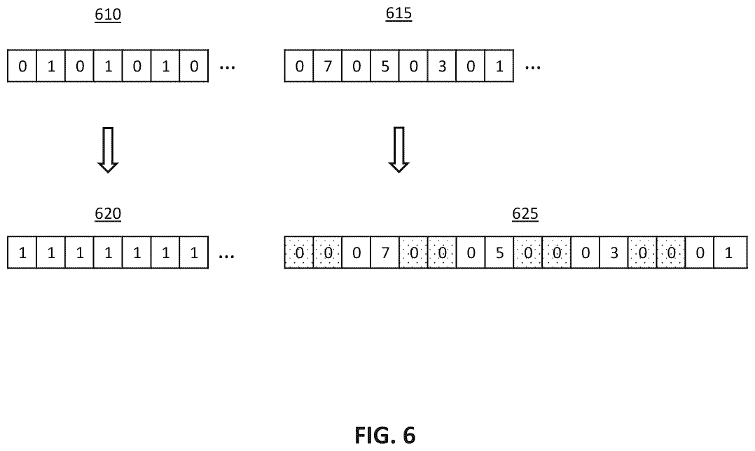

In some embodiments (e.g., embodiments where the load module 500 operates in the dense mode), the MUX 530 may transmit the weights and the weight sparsity tensor to the densification unit 533, and the MUX 540 may transmit the weights and the weight sparsity tensor to the densification unit 533. The densification unit 533 may densify the activations and the weights, send the dense activation tensor to the activation storage unit 535, and send the dense weight tensor to the weight storage unit 545. More information about densification is provided below in conjunction with FIG. 6.

FIG. 6 illustrates a densification process, in accordance with various embodiments. The densification process may be performed by a densification unit in a load module, e.g., the densification unit 533 in FIG. 5. The densification unit 533 receives a sparsity bitmap 610 and a sparse tensor 615. For the purpose of simplicity and illustration, FIG. 6 shows seven sparsity elements of the sparsity bitmap 610 (0, 1, 0, 1, 0, 1, and 0) and shows four data elements of the sparse tensor 615, each data element has two bytes. In some embodiments, the sparsity bitmap 610 is an activation sparsity tensor, and the sparse tensor 615 is an activation sparse tensor. In other embodiments, the sparsity bitmap 610 is a weight sparsity tensor, and the sparse tensor 615 is a weight sparse tensor.

The densification unit 533 densifies the sparse tensor 615 based on the sparsity bitmap 610 and generates a dense tensor 625. In the embodiments of FIG. 6, each sparsity element having a value of one corresponds to a data element in the sparse tensor 615. Each sparsity element having a value of zero does not correspond to any data element in the sparse tensor 615. To generate the dense tensor 625, the densification unit 533 added four zeros into the sparse tensor 615. The added zeros are represented by the shaded shapes in FIG. 6. Each of these zeros corresponds to a sparsity element having a value of zero in the sparse tensor 615.

The dense tensor 625 has the same number of elements as the sparsity bitmap 610. Each zero-valued sparsity elements of the sparsity bitmap 610 corresponds to a respective zero-valued data element of the dense tensor 625. The position/index of the zero-valued sparsity element in the sparsity bitmap 610 is the same as the position/index of the valued data element in the dense tensor 625. The densification unit 533 may determine positions of the inserted zeros in the dense tensor 625 based on the sparsity bitmap 610. The dense tensor 625 has a new sparsity bitmap 620. All elements of the sparsity bitmap 620 are ones as there is no sparsity in the dense tensor 625.

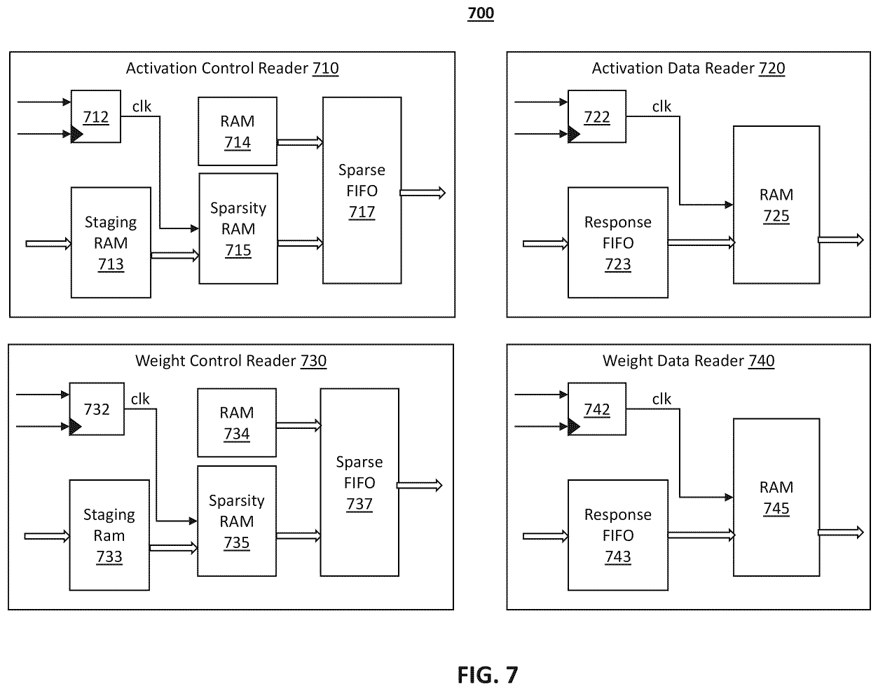

FIG. 7 illustrates readers in an example load module 700, in accordance with various embodiments. The load module 700 may be an example of the load module 360 in FIG. 3 or the load module 500 in FIG. 5. FIG. 7 shows four readers in the load module 700: an activation control reader 710, an activation data reader 720, a weight control reader 730, and a weight data reader 740. The activation control reader 710 and the activation data reader 720 may be in an activation load unit, e.g., the activation load unit 510. The weight control reader 730 and the weight data reader 740 may be in a weight load unit, e.g., the weight load unit 520.

The activation control reader 710 includes a staging RAM (random-access memory) 713, a sparsity RAM 715, a sparsity FIFO 717, a clocking unit 712, and a RAM 714. The activation data reader 720 includes a clocking unit 722, a response FIFO 723, and a RAM 725. The weight control reader 730 includes a staging RAM 733, a sparsity RAM 735, a sparsity FIFO 737, a clocking unit 732, and a RAM 734. The weight data reader 740 includes a clocking unit 742, a response FIFO 743, and a RAM 745. In other embodiments, the activation control reader 710, activation data reader 720, weight control reader 730, or weight data reader 740 may include fewer, more, or different components.

In some embodiments, the activation control reader 710 or the weight control reader 730 may generate relative address pointers based on tensor dimensions and sparsity information. The address pointers may be sent to the activation data reader 720 or the weight data reader 740 where the final address is generated. The sparsity information required to generate address pointers in the activation control reader 710 may be stored in a sparsity RAM in the activation control reader 710. The sparsity information required to generate address pointers in the weight control reader 730 may be stored in a sparsity RAM 735 in the weight control reader 730. When sparsity is disabled dynamically, then the sparsity RAM 715 and 735 may be clock/power gated dynamically to save power. The clocking unit 712 may control and send out clock signals for clocking the sparsity RAM 715. The clocking unit 732 may control and send out clock signals for clocking the sparsity RAM 735.

The RAM 725 in the activation data reader 720 may store compressed activations before the activations are sent to the sparse cell array 370. The RAM 745 in the weight data reader 740 may store compressed weights before the weights are sent to the sparse cell array 370. When sparsity is disabled dynamically, the data may be already in the correct format to be sent to the sparse cell array 370 and there is no need to store compressed data. In such cases, the RAM 725 or the RAM 745 can be dynamically clock/power gated to save power. The clocking unit 722 may control and send out clock signals for clocking the RAM 725. The clocking unit 742 may control and send out clock signals for clocking the RAM 745.

FIG. 8 illustrates an example sparse cell 800 in a combined sparsity mode, in accordance with various embodiments. The sparse cell 800 may be in a sparse cell array, e.g., the sparse cell array 370 in FIG. 3. The sparse cell 800 includes 16 MAC units 810 (individually referred to as “MAC unit 810”) arranged in four rows and four columns, 16 weight register files 820 (individually referred to as “weight register file 820”), 16 activation register files 830 (individually referred to as “activation register file 830”), four row buffers 840 (individually referred to as “row buffer 840”), a transpose module 850, and four sparsity modules 860 (individually referred to as “sparsity module 860”). In other embodiments, the sparse cell 800 may include fewer, more, or different components. For instance, the sparse cell may include a different number of MAC units 810, weight register files 820, activation register files 830, row buffers 840, or sparsity modules 860.

The MAC units 810 are configured to perform MAC operations. Each MAC unit 810 may include one or more multipliers and one or more adders. A multiplier may multiply an activation with a weight at a time to compute a product. In some embodiments (e.g., embodiments where the MAC unit 810 includes multiple multipliers), the multipliers may operate simultaneously to process multiple activation-weight pairs and compute multiple products in one cycle. An adder may accumulate products computed by the multipliers. Even though not shown in FIG. 8, the sparse cell may include an adder tree including a plurality of adder tiers. The first tier may receive outputs of a plurality of MAC units 810. The number of adders in the first tier may be half of the number of the MAC units 810, and each adder may accumulate the outputs of two MAC units 810. The second tier may receive outputs of adders in the first tier. The number of adders in the second tier may be half of the number of adders in the first tier, and each adder in the second tier may accumulate the outputs of two adders in the first tier. The adder tree may include one or more other tiers. The last tier may include a single adder that accumulates outputs of adders in the second last tier to compute a partial sum of the sparse cell 800.

The weight register files 820 store weights to be processed in MAC operations. In the embodiments of FIG. 8, four weight register files 820 are grouped into a storage set that stores data to be used by a column of MAC units 810. There are four storage sets corresponding to the four columns of MAC units 810. In some embodiments, a weight register file 820 may correspond to a MAC unit 810 and store data to be processed by the MAC unit. In some embodiments, all the 16 weight register files 820 constitute a weight storage unit, which may be an example of the weight storage unit 545 in FIG. 5.

The activation register files 830 stores activations to be processed in MAC operations. In the embodiments of FIG. 8, four activation register files 830 are grouped into a storage set that stores data to be used by a row of MAC units 810. There are four storage sets corresponding to the four rows of MAC units 810. In some embodiments, an activation register file 830 may correspond to a MAC unit 810 and store data to be processed by the MAC unit. In some embodiments, all the 16 activation register files 830 constitute an activation storage unit, which may be an example of the activation storage unit 535 in FIG. 5.

The row buffers 840 store outputs of the MAC units 810. Each row buffer 840 may drain outputs of a single row of MAC units 810. Data stored in the row buffers 840, such as output operands, may be further transmitted to the transpose module 850. The transpose module 850 may operate in either an activation sparsity mode or a weight sparsity mode. In some embodiments, the transpose module 850 may transpose the output operands in one of the two sparsity modes and keep the output operands as is in the other sparsity mode.

The sparsity module 860 facilitates dynamic sparsity-based acceleration in the sparse cell 800. In the embodiments of FIG. 8, each sparsity module 860 includes a sparsity tensor storage unit 865 and a control logic 867. The sparsity tensor storage unit 865 stores combined sparsity tensors. A combined sparsity tensor stored in the sparsity tensor storage unit 865 may correspond to an activation tensor and a weight tensor. A nonzero element in the combined sparsity tensor may correspond to a nonzero activation-weight pair that includes a nonzero activation and a nonzero weight. The position of the nonzero activation in the activation tensor may match the position of the nonzero weight in the weight tensor. The product of the nonzero activation and nonzero weight would be nonzero.

The control logic 867 may control transmission of activations and weights stored from the weight register files 820 and the activation register files 830 to the MAC units 810 based on sparsity tensors. For instance, the control logic 867 may select a subset of the weights stored in the weight register files 820 and select a subset of activations stored in the activation register files 830 based on a combined sparsity tensor. The selected weights and activations constitute nonzero activation-weight pairs. The control logic 867 may transmit the selected weights and activations to the MAC units 810 for performing MAC operations. The other weights stored in the weight register files 820 and the other activations stored in the activation register files 830 are skipped from computation. In the embodiments of FIG. 8, each sparsity module 860 controls sparsity acceleration in a respective MAC unit 810. As the sparsity acceleration is either based on both weight sparsity and activation sparsity, 16 sparsity modules 860 are used for acceleration computations in the 16 MAC units 810.

As shown in FIG. 8, the sparse cell 800 is associated with MUXs 803, 804, 805, and 806. In other embodiments, the sparse cell 800 may be associated with a different number of MUXs or other devices. The MUX 803 facilitates loading weights, e.g., from the local memory 340, into the weight register files 820. An example of the MUX 803 may be the MUX 530 in FIG. 5. The MUX 804 facilitates loading activations, e.g., from the local memory 340, into the activation register files 830. An example of the MUX 804 may be the MUX 540 in FIG. 5. The MUX 805 facilitates loading sparsity tensors into the sparsity tensor storage unit 865. An example of the MUX 805 may be the MUX 550 in FIG. 5. The MUX 806 may be a drain MUX that can facilitate draining outputs of the MAC units 810, e.g., to the local memory 340.

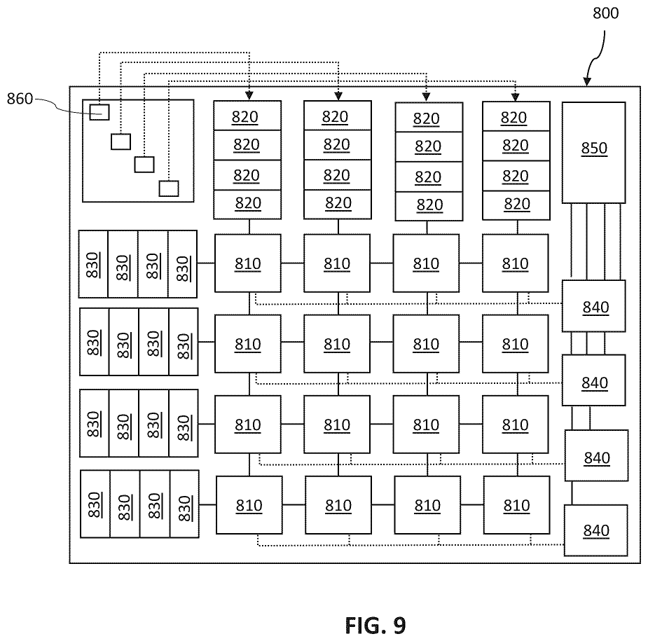

FIG. 9 illustrates the sparse cell 800 in a one-sided sparsity mode, in accordance with various embodiments. The one-sided sparsity mode may be an activation sparsity mode or a weight sparsity mode. In the embodiments of FIG. 9, the sparsity tensor storage unit 865 of a sparsity module 860 stores either an activation sparsity tensor or weight sparsity tensor, depending on which side the sparsity acceleration is. The control logic 867 may control transmission of weights and activations stored from the weight register files 820 and the activation register files 830 to the MAC units 810 based on the activation sparsity tensor or weight sparsity tensor.

In an example where the one-sided sparsity mode is a weight sparsity mode, the control logic 867 may select a subset of the activations stored in the activation register files 830 based on the weight sparsity tensor and transmits the selected activations to the MAC units 810 for computation. The other activations stored in the activation register files 830 are skipped from computation. The position of a selected activation in the activation tensor may match the position of a nonzero element in the weight sparsity tensor so that the weight to be multiplied with the selected activation is nonzero.

In an example where the one-sided sparsity mode is an activation sparsity mode, the control logic 867 may select a subset of the weights stored in the weight register files 820 based on the activation sparsity tensor and transmits the selected weights to the MAC units 810 for computation. The other weights stored in the weight register files 820 are skipped from computation. The position of a selected weight in the weight tensor may match the position of a nonzero element in the activation sparsity tensor so that the activation to be multiplied with the selected weight is nonzero.

In the embodiments of FIG. 8, each sparsity module 860 controls sparsity acceleration in a respective column of MAC units 810. The MAC units 810 in the column may process the same sparse tensor but different dense tensors (or the same dense tensor but different sparse tensors) in a single computation round. As the sparsity acceleration is either based on weight or activation (but not both), four sparsity modules 860 can be sufficient for the 16 MAC units 810. FIG. 9 shows the four sparsity modules 860 activated for the one-sided sparsity mode and does not show the other sparsity module 860. The other 12 sparsity modules 860 may be gated or deactivated to save power. The gating or deactivation of the other sparsity modules 860 may be controlled by clock signals.

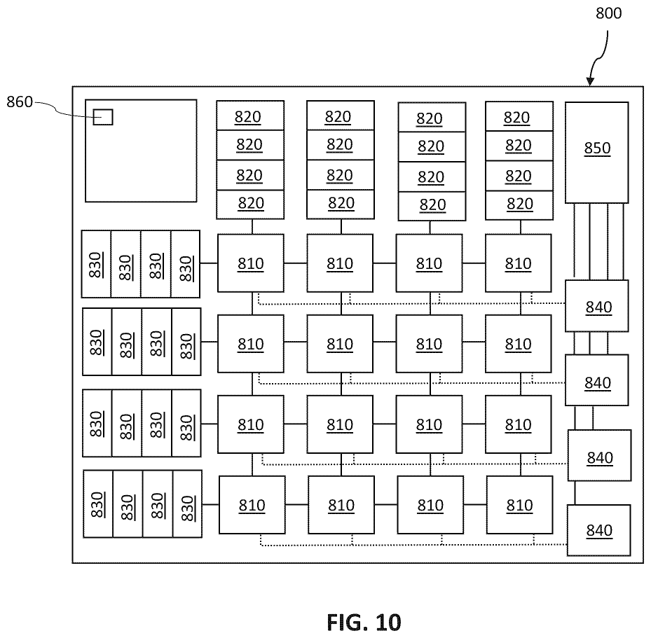

FIG. 10 illustrates the sparse cell 800 in a dense mode, in accordance with various embodiments. In the dense mode, no sparsity-based acceleration is performed. In the embodiments of FIG. 10, one sparsity module 860 is activated for the dense mode, while the other sparsity module 860 may be gated or deactivated to save power. The weight register files 820 store dense weight tensors. The activation register files 830 store dense activation tensors. The sparsity tensor storage unit 865 of the sparsity module 860 may store no sparsity tensors. The sparsity tensor storage unit 865 may be gated or deactivated to save power. The control logic 867 may transmit the weights stored in the weight register files 820 and the activations stored in the activation register files 830 to the MAC units 810 for computation. In some embodiments, all the weights stored in the weight register files 820 and all the activations stored in the activation register files 830 are used in MAC operations by the MAC units 810.

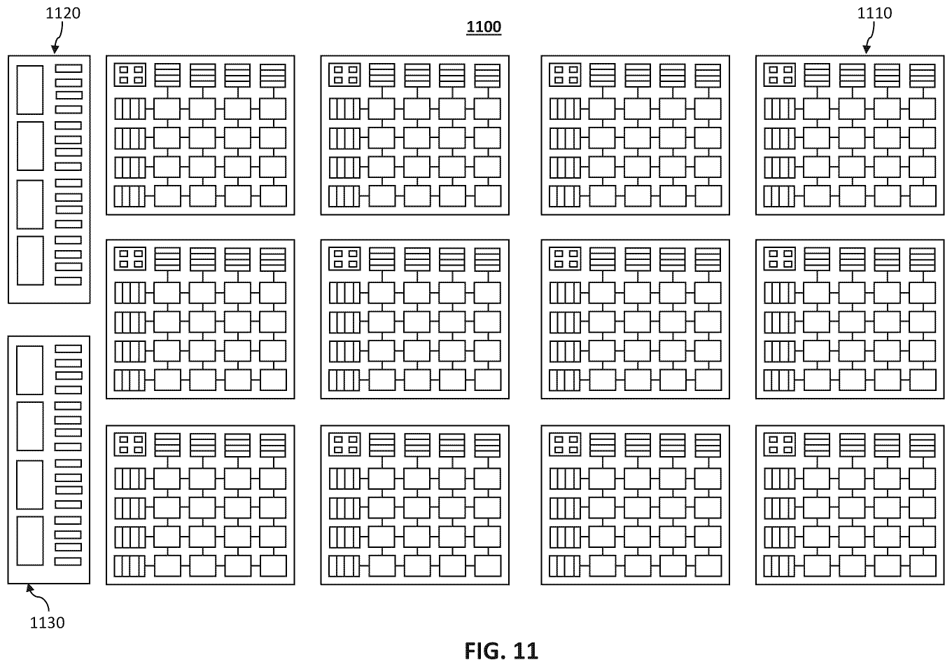

FIG. 11 illustrates a sparse cell array 1100, in accordance with various embodiments. The sparse cell array 1100 may be an example of the sparse cell array 370 in FIG. 3. In FIG. 11, the sparse cell array 1100 includes sparse cells 1110 (individually referred to as “sparse cell 1110”) arranged in four columns and four rows, an activation memory 1120, and a weight memory 1130. In other embodiments, the sparse cell array 1100 may include fewer, more, or different components. For instance, the sparse cell array 1100 may include a different number of columns, rows, or sparse cells 1110.

Each sparse cell 1110 may perform sparsity accelerated MAC operations. The sparse cells 1110 may facilitate dynamic sparsity mode. For instance, the sparsity modes of the sparse cells 1110 may be dynamically changed between a combined sparsity mode, an activation sparsity mode, a weight sparsity mode, and a dense mode. An embodiment of a sparse cell 1110 may be the sparse cell 800 in FIG. 8. The activation memory 1120 stores activations, such as activations in input tensors of deep learning operations. Activations may be loaded from the activation memory 1120 to sparse cells 1110. The weight memory 1130 stores weights, such as weights in filters of deep learning operations. Weights may be loaded from the weight memory 1130 to sparse cells 1110. The activation memory 1120 or weight memory 1130 may be a buffer. In other embodiments, the sparse cell array 1100 may include a dense data memory and a sparse data memory in lieu of the activation memory 1120 and weight memory 1130. The dense data memory may store dense tensors, e.g., dense tensors generated by the load module 360. The sparse data memory may store sparse tensors.

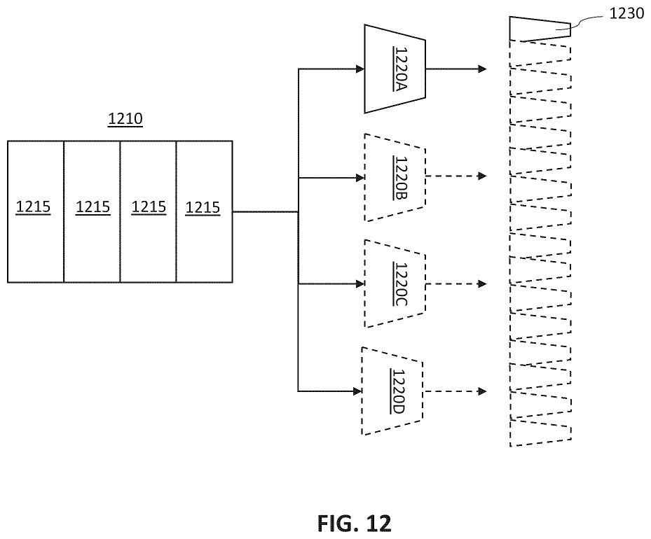

FIG. 12 illustrates read ports 1230 in a sparse cell, in accordance with various embodiments. The sparse cell may be the sparse cell 800 in FIGS. 8-10 or a sparse cell 1110 in FIG. 11. The read ports 1230 are coupled to four MUXs 1220A-1020D, collectively referred to as “MUXs 1220” or “MUX 1220.” An example of a MUX 1220 may be a 64:16 MUX. The MUXs 1220 are coupled to a storage unit 1210. For the purpose of illustration, the storage unit 1210 includes four register files, individually referred to as “register file 1215.” A registered file 1215 may store an operand (e.g., an activation operand or weight operand) at a time. In some embodiments, a MUX 1220 may correspond to a column of MAC units in a sparse cell. In the embodiments of FIG. 12, each column has four MAC units. In other embodiments, a column may have a different number of MAC units. In some embodiments, a read ports 1230 may be associated with an address. The address may be encoded in a sequence of bits (e.g., 4, 8, etc.). In some embodiments, the least significant address bits may be fixed to the port index and the most significant bits may be determined by a counter. The storage unit 1210, MUX 1220, and read ports 1230 may be used for the activation side or the weight side. The storage unit 1210 may be a weight storage unit or an activation storage unit.

In embodiments where the sparse cell operates in a combined sparsity mode, the MAC units in the column would process different data elements. To support the combined sparsity acceleration, each MUX 1220 may direct the corresponding operand to four read ports 1230 (individually referred to as a “read port 1230”). A read port 1230 may correspond to a different MAC unit in the column and may facilitate transmission of data elements in the operand to the MAC units. In the combined sparsity mode, as there are four activation operands for four columns of MAC units, the total number of read ports 1230 needed for transferring the activation operands is 16. Similarly, as there are four weight operands for four columns of MAC units, the total number of read ports 1230 needed for transferring the weight operands is also 16.

In embodiments where the sparse cell operates in a one-sided sparsity mode, one MUX 1220A and a read port 1230 coupled to the MUX 1220A may be used for sparse side. All the MAC units in the same column may move in lockstep as each MAC unit would process a sparse operand plus a dense operand. With one side being dense, the MAC units in the column can progress potentially in lockstep with all the MAC units requiring accessing a single sparse operand. Accordingly, a single read port 1230 would be sufficient to load the sparse operands to the column. The other MUXs 1220 and the other read ports 1230 may be gated or deactivated to save power. All the MUX 1220 and all the read ports 1230 may still be needed for the dense side. In embodiments where the sparse cell operates in a dense mode, both sides may each need one MUX 1220 and one read port 1230, and the other MUXs 1220 and the other read ports 1230 may be deactivated.

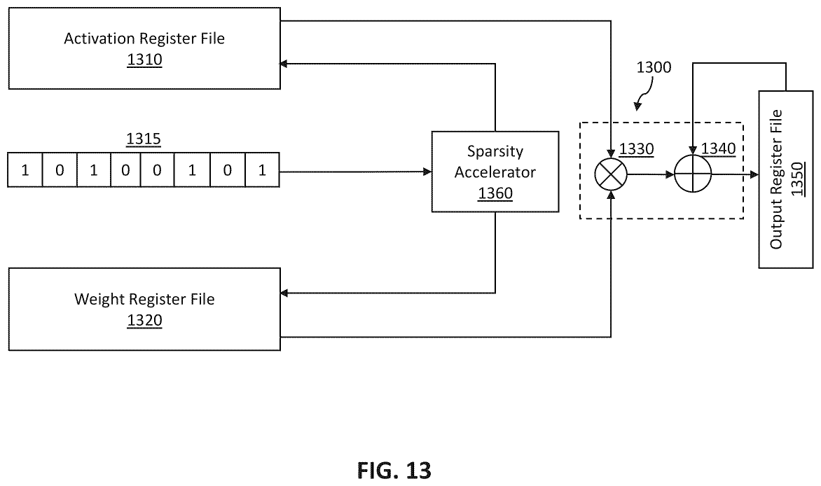

FIG. 13 illustrates sparsity acceleration in an MAC operation by a MAC unit 1300, in accordance with various embodiments. The MAC unit 1300 may be a unit component of a sparse cell, e.g., the sparse cell 800 or a sparse cell 1110. In the embodiments of FIG. 13, the MAC unit 1300 is coupled to an activation register file 1310, a weight register file 1320, an output register file 1350, and a sparsity accelerator 1360. The MAC unit 1300 includes a multiplier 1330 and an adder 1340. In other embodiments, the MAC unit 1300 may include fewer, more, or different components. The multiplier 1330 and adder 1340 may constitute an MAC unit. The activation register file 1310 may be an example of the activation register files 830 in FIGS. 8-10. The weight register file 1320 may be an example of the weight register files 820 in FIGS. 8-10. The activation register file 1310 may be in an activation storage unit, e.g., the activation storage unit 535 in FIG. 5. The weight register file 1320 may be in a weight storage unit, e.g., the weight storage unit 545 in FIG. 5.

The activation register file 1310 stores an activation operand. The weight register file 1320 stores a weight operand. The sparsity accelerator 1360 receives a sparsity bitmap 1315 that corresponds to the sparse tensor in the weight register file 1320. The sparsity bitmap 1315 may be a combined sparsity bitmap when the MAC unit 1300 operates in a combined sparsity mode. The sparsity bitmap 1315 may be an activation sparsity bitmap when the MAC unit 1300 operates in an activation sparsity mode. The sparsity bitmap 1315 may be a weight sparsity bitmap when the MAC unit 1300 operates in a weight sparsity mode. The sparsity bitmap 1315 may have the same size (e.g., the same number of elements) as or a larger size than the activation operand or the weight operand.

Using the sparsity bitmap 1315, the sparsity accelerator 1360 selects four activations from the activation register file 1310 and selects four weights from the weight register file 1320. The sparsity accelerator 1360 transmits the selected activations and weights to the multiplier 1330. These selected data elements correspond to the nonzero valued elements of the sparsity bitmap 1315. The four selected activations and the four selected weights may constitute four activation-weight pairs. The multiplier 1330 may compute a product based on each activation-weight pair and therefore, compute four products in total. The four products may be provided to the adder 1340. Even though FIG. 13 shows a single multiplier 1330, the MAC unit 1300 may include multiple multipliers that can perform multiple multiplication operations at the same time.

The adder 1340 accumulates the four products and computes a unit-level internal partial sum. The four unselected elements of the dense tensor are not processed to save power and time, which would not impact the value of the unit-level internal partial sum. For instance, when the dense tensor is a dense activation tensor, the weights corresponding to the unselected activations are zeros so the products of the unselected activations and the weights would all be zero and have no contribution to the unit-level internal partial sum or other partial sums computed by the sparse cell. Similarly, when the dense tensor is a dense weight tensor, the activations corresponding to the unselected weights are zeros so the products of the unselected weights and the activations would all be zero and have no contribution to the unit-level internal partial sum or other partial sums computed by the sparse cell.

The unit-level internal partial sum may be stored in the output register file 1350. In some embodiments, the adder 1340 receives one or more unit-level internal partial sums from one or more other MAC units. The adder 1340 can accumulate the one or more unit-level internal partial sums with the unit-level internal partial sum of the MAC unit 1300 and store the result of the accumulation (i.e., a multi-PE internal partial sum) in the output register file 1350. The one or more other MAC units may be in the same column as the MAC unit 1300 in a sparse cell. The multi-unit internal partial sum may be a column-level internal partial sum. In some embodiments, the unit-level internal partial sum of the MAC unit 1300 or the multi-unit internal partial sum may be sent to one or more other MAC units for further accumulation.

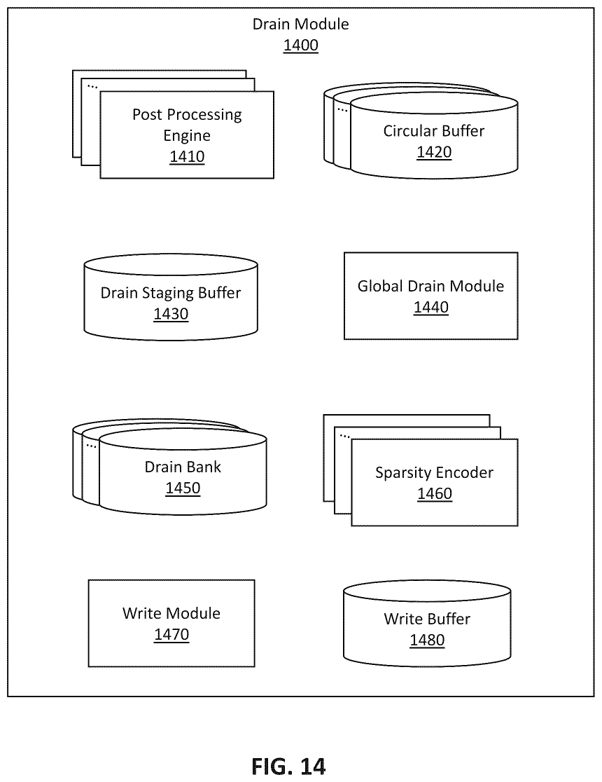

FIG. 14 illustrates an example drain module, in accordance with various embodiments.

FIG. 14 is a block diagram of a drain module 1400, in accordance with various embodiments. The drain module 1400 extracts output activations computed by sparse cells (e.g., sparse cells in the sparse cell array 360, the sparse cell 800, the sparse cells 1110, etc.) and writes the output activations into memories (e.g., the local memory 340). The drain module 1400 may be an example of the drain module 380 in FIG. 3. As shown in FIG. 14, the drain module 1400 includes post processing engines 1410 (individually referred to as “post processing engine 1410”), circular buffers 1420 (individually referred to as “circular buffer 1420”), a drain staging buffer 1430, a global drain module 1440, drain banks 1450 (individually referred to as “drain bank 1450”), sparsity encoders 1460 (individually referred to as “sparsity encoder 1460”), a write module 1470, and a write buffer 1480. In other embodiments, alternative configurations, different or additional components may be included in the drain module 1400. Further, functionality attributed to a component of the drain module 1400 may be accomplished by a different component included in the drain module 1400 or a different module or system.

The post processing engines 1410 process outputs of a sparse cell array, e.g., the sparse cell array 370. In some embodiments, a post processing engine 1410 computes activation functions. The post processing engine 1410 may receive outputs of the sparse cell array 370 as inputs to the activation functions. In addition or alternative to activation functions, the post processing engine 1410 may perform other types of post processing on outputs of the sparse cell array 370. For instance, the post processing engine 1410 may apply a bias on an output of the sparse cell array 370. The post processing engine 1410 may transmit the results of the post processing to the circular buffers 1420. The output data stored in the circular buffers 1420 may be further transmitted and written into the drain staging buffer 1430.

The global drain module 1440 may select activations stored in the drain staging buffer 1430. In some embodiments, the global drain module 1440 selects activations in a predetermined manner, e.g., a 1×1×OC manner. In some embodiments, the global drain module 1440 selects one of a predetermined number of entries of the drain staging buffer 1430. The predetermined number may be the number of MAC units in a column of the sparse cell. In other embodiments, the global drain module 1440 may select a predetermined amount of data, e.g., 16 bytes, 32 bytes, and so on. After the entries are selected, the global drain module 1440 may select one or more drain banks 1450 and multicast the selected entries to the selected drain bank(s) 1450. In an example, the global drain module 960 may have 16 drain banks 1450 in four groups. Each group may include 4 drain banks 1450. The global drain module 1440 may assign the right rotate value specific to each drain bank 1450 to align and concatenate the consecutive output channels (OCs) in a single drain bank 1450. The global drain module 1440 may further write the correct set of bytes in the selected line of the drain staging buffer 1430 to the drain bank 1450.

In some embodiments, a single drain bank 1450 may store an activation vector including activations having the same (OX, OY) coordinate but different OCs. The activations of the activation vector may be arranged in sequence in accordance with their OCs. For instance, the OC coordinate of the first activation in the activation vector may be in 0, the OC coordinate of the second activation may be in 1, the OC coordinate of the third activation may be in 2, and so on. Different drain banks 1450 may store different activation vectors. The activations in different drain banks 1450 may have different OX coordinates or different OY coordinates.

A sparsity encoder 1460 converts dense data to compressed data based on sparsity in the dense data. In some embodiments, a sparsity encoder 1460 may receive output activations (e.g., the output tensor 230 in FIG. 2) of a layer, e.g., from the global drain module 1440. The output activations may be arranged in activation vectors. The sparsity encoder 1460 may generate a compressed version of one or more activation vectors. In some embodiments, the sparsity encoder 1460 may compress an activation vector based on an activation threshold. The sparsity encoder 1460 may compare the absolute value of each activation with the activation threshold. The sparsity encoder 1460 may remove any activations whose absolute value is no greater than the activation threshold from the activation vector to generate a compressed activation vector. The activation threshold may be zero. The removed activations may not be stored in the write buffer 1480 or the local memory to save bandwidth and memory usage.

In some embodiments, a sparsity encoder 1460 may also generate one or more sparsity tensors of the activation vector. The sparsity tensor may include sparsity elements, each of which corresponds to a different activation in the activation vector and indicates whether the corresponding activation is removed or not. In some embodiments, the sparsity tensor may be a sparsity bitmap, and a sparsity element in the sparsity bitmap may be a bit. A zero bit may indicate that the corresponding activation is removed and not in the compressed activation vector, while a one bit may indicate that the corresponding activation is not removed and is in the compressed activation vector.

In some embodiments, a sparsity encoder 1460 may encode sparsity on a context level. A context may be a portion of the output tensor generated by the sparse cell array. In an example, the context may be an activation vector including activations that have the same (X, Y) coordinate but different Z coordinates. The context may be processed in the next DNN layer, e.g., by one or more MAC units. For a given context, the sparsity encoder 1460 may read in multiple lines from a data bank before emitting a single line of N bytes (where N is an integer, such as 16, 32, 64, etc.), depending on the sparsity level. As the elements in a context stream may come over multiple rounds, the sparsity encoder 1460 can save data indicating a state of the context (“context state”) in a buffer and retrieve the context state back later from the buffer. A context state may include the compressed context, sparsity tensor of the context, activations in the compressed context, and line counts.

The write module 1470 determines memory addresses of output activations and writes the output activations into a memory based on the memory addresses. An example of the memory may be the local memory 340. In some embodiments, the write module 1470 determines memory address of activations in the compressed activation vectors. The write module 1470 may avoid the determination of memory addresses for activations removed by the sparsity encoder 1460. The write module 1470 may use the position of an activation in the output tensor of the deep learning operation to generate a memory address for the activation. For instance, the write module 1470 may compute the 3D coordinate (e.g., a (OX, OY, OC) coordinate) of the activation. The write module 1470 may identify the location of any (OX, OY, OC) coordinate of the output tensor in the memory.

In some embodiments (e.g., embodiments where the sparsity encoder 1460 compresses the output tensor), the write module 1470 may write compressed activation vectors generated by the sparsity encoder 1460 into the memory. The write module 1470 may skip activations removed by the sparsity encoder 1460 in the compression process. The write module 1470 may also write sparsity tensors generated by the sparsity encoder 1460 into the memory or a separate memory. In some embodiments, the write module 1470 may determine memory addresses of sparsity tensors associated with the output tensor and write the sparsity tensors to the memory based on the memory addresses.

To write an activation vector or sparsity tensor into the memory, the write module 1470 may generate a write request that includes the memory address(se) of the activation vector or sparsity tensor and transmit the write request to the memory. The memory, after receiving the write request, may process the write request and store the activation vector or sparsity tensor in one or more data write operations. The write buffer 1480 may store the activation vector, sparsity tensor, or the write request while the write request or one or more previous write requests are being processed by the memory.

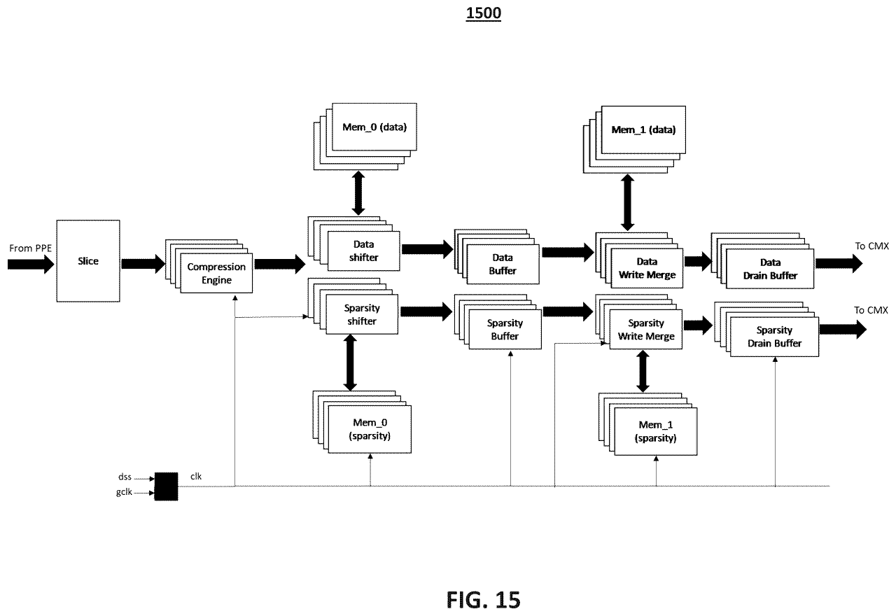

FIG. 15 illustrates an example data draining path 1500, in accordance with various embodiments. The data draining path 1500 includes internal components of a sparsity encoder and other sparsity related data structures in a drain module, which may be an example of the drain module 380 in FIG. 3 or the drain module 1400 in FIG. 14. The data draining path 1500 may receive the data from sparse cells or post processing engines and writes the data out to memory in a desired tensor shape. Operations performed by the sparse cell and post processing performed by the post processing engines could result in data that has zeros, e.g., due to execution of an activation function (e.g., ReLU). The data draining path 1500 may compress this data, when sparsity is enabled, to save on memory storage and the number of memory writes. The data draining path 1500 may conduct the compression to create separate activation data and sparsity tensor, which may follow separate and parallel paths to memory. The Sparsity shifter, Mem_0(sparsity), Sparsity Buffer, Sparsity write-merge, Mem_1(sparsity) and Sparsity Drain Buffer blocks shown in FIG. 15 may ensure efficient write out of sparsity tensor to memory. When sparsity is dynamically disabled, the blocks can be gated off to reduce power. As shown in FIG. 15, some of the components in the data draining path 1500 may receive a clock signal (represented by “clk” in FIG. 15) and be deactivated based on the clock signal.

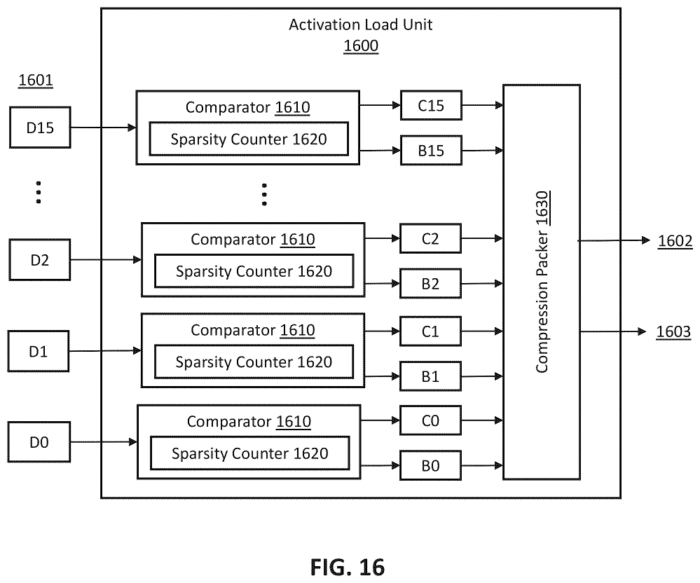

FIG. 16 illustrates an example sparsity encoder 1600, in accordance with various embodiments. The sparsity encoder 1600 may be an example of the sparsity encoders 1460 in FIG. 14. As shown in FIG. 16, the sparsity encoder 1600 includes comparators 1610 (individually referred to as “comparator 1610”), each of which includes a sparsity counter 1620, and a compression packer 1630. For the purpose of illustration, FIG. 16 shows 16 comparators 1610 and 16 sparsity counters 1620. In other embodiments, the sparsity encoder 1600 may include a different number of comparators 1610 or sparsity counters 1620.

In the embodiments of FIG. 16, the sparsity encoder 1600 receives an activation tensor 1601 that includes 16 activations represented as D0-D15 in FIG. 16. The activation tensor may be an output operand computed in a sparse cell, e.g., the sparse cell 800 or 1110. Each comparator 1610 receives a different activation in the activation tensor 1601 and compresses the activation with a predetermined value. The predetermined value may be zero in some embodiments. In other embodiments, the predetermined value may be nonzero. The comparator 1610 may change the value of an activation having a value lower than the predetermined value to zero and output zero. For an activation having a value not lower than the predetermined value, the comparator 1610 may output the activation as is. The data elements output from the comparators 1610 are C0-C15. Each comparator 1610 may also output a bit indicating whether the data element output from the comparator is zero or not. In an example, when the output is zero, the bit is zero; when the output is nonzero, the bit is one. The bits are represented as B0-B15 in FIG. 16. The data elements and bits are provided to the compression packer 1630.

The compression packer 1630 may generate a compressed activation vector 1602 that includes the nonzero data elements output from the comparators 1610. All the data elements in the compressed activation vector 1602 may be nonzero. The compressed activation vector 1602 may have a smaller size (e.g., less data elements) than the activation tensor 1601. The compression packer 1630 also generates a sparsity tensor 1603 that indicates positions of the data elements of the compressed activation vector 1602 in the activation tensor 1601. In some embodiments, the compression packer 1630 generates the sparsity tensor 1603 using the bits B0-B15. The sparsity tensor 1603 may have the same size as the activation tensor 1601.

Example Method of Selecting Sparsity Mode

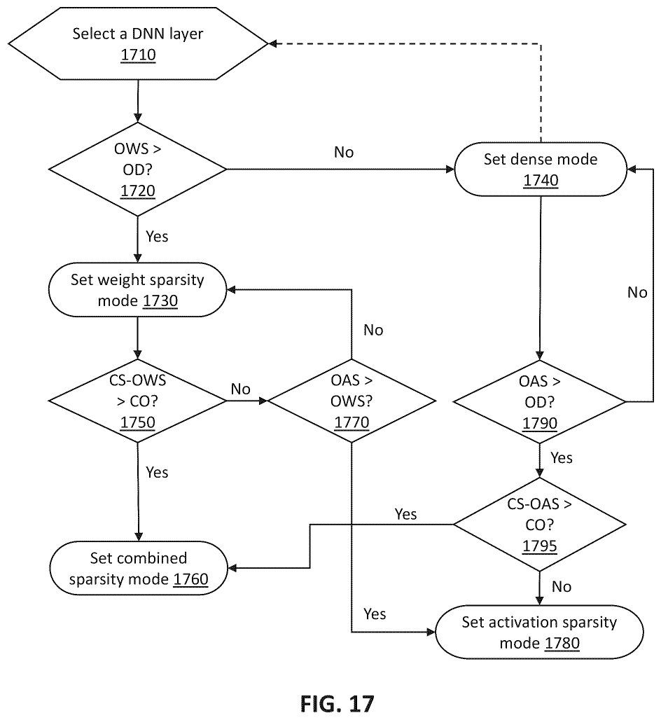

FIG. 17 is a flowchart showing a method 1700 of selecting sparsity mode, in accordance with various embodiments. The method 1700 in FIG. 17 includes Steps 1710, 1720, 1730, 1740, 1750, 1760, 1770, 1780, 1790, and 1795. The steps 1710, 1720, 1730, and 1740 may be performed by the weight sparsity module 450 in FIG. 4. The other steps may be performed by the sparsity mode module 350 in FIG. 3. Although the method 1700 is described with reference to the flowchart illustrated in FIG. 17, many other methods for selecting sparsity mode may alternatively be used. For example, the order of execution of the steps in FIG. 17 may be changed. As another example, some of the steps may be changed, eliminated, or combined.

The weight sparsity module 450 selects a DNN layer in Step 1710. In some embodiments, the DNN layer may be a convolutional layer, such as the convolutional layer 110 in FIG. 1. The weight sparsity module 450 may select a DNN layer, the computation in which can be accelerated based on sparsity in activation or weights. For instance, the weight sparsity module 450 may select a DNN layer that has or is expected to have zero-valued activations or zero-valued weights.

After the DNN layer is selected, the weight sparsity module 450 determines whether a weight sparsity score (“OWS”) is greater than a threshold score (“OD”) in Step 1720. The weight sparsity score may indicate the amount of sparsity in a weight tensor of the layer selected in Step 1710. In an example, the weight sparsity score may be a percentage indicating the percentage of zero-valued weights in the weight tensor. In another example, the weight sparsity score may be a ratio of the number of zero-valued weights in the weight tensor to the total number of weights in the weight tensor. The threshold score may be a ratio of estimated power consumption of executing the layer in a weight sparsity mode to estimated power consumption of executing the layer in a dense mode.

In embodiments where OWS is greater than OD, the weight sparsity module 450 sets the sparsity mode for the layer to the weight sparsity mode in Step 1730. The weight sparsity module 450 may generate a configuration parameter encoding the setting of the weight sparsity mode. The configuration parameter may be provided to the sparsity mode module 350.

The sparsity mode module 350 determines whether a combined sparsity score (CS-OWS) is greater than a threshold score (CO) in Step 1750. The combined sparsity score may indicate the amount of sparsity in the output tensor computed from the activation tensor and weight tensor through one or more MAC operations. In an example, the combined sparsity score may be a percentage indicating the percentage of zero-valued elements in the output tensor. In another example, the weight sparsity score may be a ratio of the number of zero-valued elements in the output tensor to the total number of elements in the output tensor. The threshold score may be a ratio of estimated power consumption of executing the layer in a combined sparsity mode to estimated power consumption of executing the layer in a weight sparsity mode.

In embodiments where CS-OWS is greater than CO, the sparsity mode module 350 sets the sparsity mode of the layer to the combined sparsity mode in Step 1760. In embodiments where CS-OWS is not greater than CO, the sparsity mode module 350 determines whether an activation sparsity score (“OAS”) is greater than OWS in Step 1770. The activation sparsity score may indicate the amount of sparsity in an activation tensor of the layer selected in Step 1710. In an example, the activation sparsity score may be a percentage indicating the percentage of zero-valued activations in the activation tensor. In another example, the activation sparsity score may be a ratio of the number of zero-valued activations in the activation tensor to the total number of activations in the activation tensor.

In embodiments where OAS is greater than OWS, the sparsity mode module 350 sets the sparsity mode of the layer to an activation sparsity mode in Step 1780. In embodiments where OAS is not greater than OWS, the sparsity mode module 350 sets the sparsity mode of the layer to the weight sparsity mode in Step 1730.

In embodiments where OWS is not greater than OD, the weight sparsity module 450 sets the sparsity mode for the layer to the dense mode in Step 1740. The weight sparsity module 450 may generate a configuration parameter encoding the setting of the dense mode. The configuration parameter may be provided to the sparsity mode module 350.

The sparsity mode module 350 determines whether OAS is greater than OD in Step 1790. In embodiments where OAS is greater than OD, the sparsity mode module 350 determines whether a combined sparsity score (CS-OAS) is greater than CO in Step 1795. The combined sparsity score may be the same as CS-OWS described above. In embodiments where CS-OAS is greater than CO, the sparsity mode module 350 sets the sparsity mode of the layer to the combined sparsity mode in Step 1780. In embodiments where CS-OAS is not greater than CO, the sparsity mode module 350 sets the sparsity mode of the layer to the activation sparsity mode in Step 1780.

Example Method of Accelerating DNN Layer

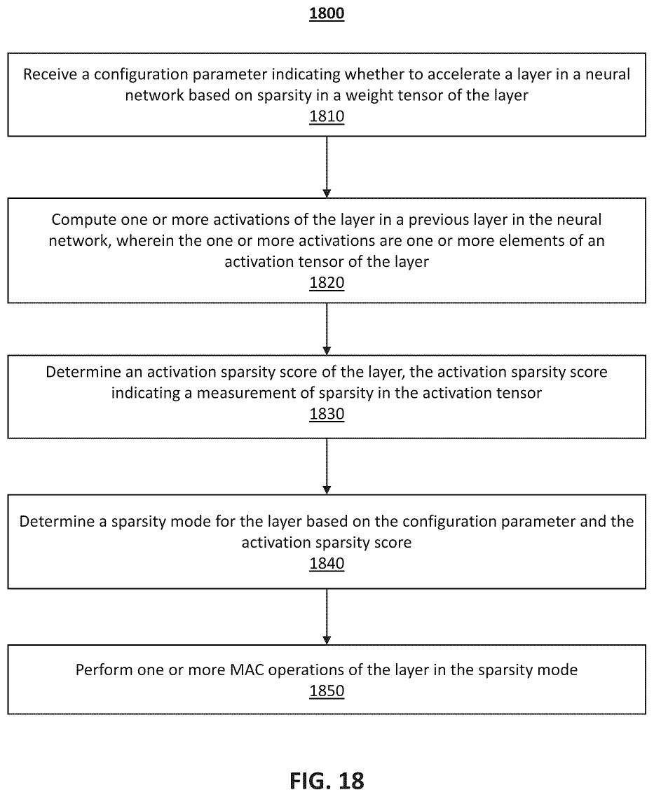

FIG. 18 is a flowchart showing a method 1800 of accelerating DNN layer, in accordance with various embodiments. The method 1800 may be performed by the DNN accelerator 302 in FIG. 3. Although the method 1800 is described with reference to the flowchart illustrated in FIG. 18, many other methods for accelerating DNN layer may alternatively be used. For example, the order of execution of the steps in FIG. 18 may be changed. As another example, some of the steps may be changed, eliminated, or combined.

The DNN accelerator 302 receives 1810 a configuration parameter indicating whether to accelerate a layer in a DNN based on sparsity in a weight tensor of the layer. In some embodiments, the DNN accelerator 302 receives the configuration parameter from the DNN module 301. In some embodiments, the configuration parameter is determined by determining a weight sparsity score of the layer, the weight sparsity score indicating a measurement of sparsity in the weight tensor and determining whether the weight sparsity score is greater than a threshold score. The threshold score indicates an estimated reduction of power consumption for executing the layer by accelerating the layer based on sparsity in the weight tensor.

The DNN accelerator 302 computes 1820 one or more activations of the layer in a previous layer in the neural network. The one or more activations are one or more elements of an activation tensor of the layer. In some embodiments, the activation tensor is an input tensor of the layer or an output tensor of the previous layer.

The DNN accelerator 302 determines 1830 an activation sparsity score of the layer. The activation sparsity score indicates a measurement of sparsity in the activation tensor. In some embodiments, the DNN accelerator 302 may determine the activation sparsity score using sparsity counters implemented in a sparsity encoder, which may be in a data draining path from a sparse cell of the DNN accelerator 302 to a memory of the DNN accelerator 302.

The DNN accelerator 302 determines 1840 a sparsity mode for the layer based on the configuration parameter and the activation sparsity score. In some embodiments, the DNN accelerator 302 determines whether the activation sparsity score is greater than a threshold score. The threshold score indicates an estimated reduction of power consumption for executing the layer by accelerating the layer based on sparsity in the activation tensor. In some embodiments, the sparsity mode is selected from a two-sided sparsity mode, a one-sided weight sparsity mode, a one-sided activation sparsity mode, and a dense mode.

The DNN accelerator 302 performs 1850 one or more MAC operations of the layer in the sparsity mode. In some embodiments, the DNN accelerator 302 transfers data from a memory to one or more MAC units, the data selected based on the sparsity mode. The one or more MAC operations are performed by the one or more MAC units. In some embodiments, the memory stores a compressed weight tensor and a weight sparsity tensor. The compressed weight tensor comprises one or more nonzero valued weights in the weight tensor. The weight sparsity tensor indicates one or more positions of the one or more nonzero valued weights in the weight tensor. The memory also stores a compressed activation tensor and an activation sparsity tensor. The compressed activation tensor comprises one or more nonzero valued activations in the activation tensor. The activation sparsity tensor indicates one or more positions of the one or more nonzero valued activations in the activation tensor. In some embodiments, the DNN accelerator 302 selects, based on the sparsity mode, the data from the compressed weight tensor, the weight sparsity tensor, the compressed activation tensor, and the activation sparsity tensor.

In some embodiments, the configuration parameter indicates to accelerate the layer based on sparsity in the weight tensor. The DNN accelerator 302 reads, from a memory, a compressed activation tensor and an activation sparsity tensor. The compressed activation tensor comprises one or more nonzero valued activations in the activation tensor. The activation sparsity tensor indicates one or more positions of the one or more nonzero valued activations in the activation tensor. The DNN accelerator 302 generates, using the activation sparsity tensor, the activation tensor by adding one or more zeros into the compressed activation tensor.

In some embodiments, configuration parameter indicates to accelerate the layer based on sparsity in the weight tensor. The DNN accelerator 302 reads, from a memory, a compressed weight tensor and a weight sparsity tensor. The compressed weight tensor comprises one or more nonzero valued weights in the weight tensor. The weight sparsity tensor indicates one or more positions of the one or more nonzero valued weights in the weight tensor. The DNN accelerator 302 accelerates the layer by skipping one or more other MAC operations of the layer based on the weight sparsity tensor.

In some embodiments, the DNN accelerator 302 computes an activation tensor of a next layer in the neural network based on the one or more MAC operations. The DNN accelerator 302 receives an additional configuration parameter indicating whether to accelerate the next layer based on sparsity in a weight tensor of the next layer. The DNN accelerator 302 determines an activation sparsity score of the next layer based on the activation tensor of the next layer. The DNN accelerator 302 determines a sparsity mode for the next layer based on the additional configuration parameter and the activation sparsity score of the next layer. The sparsity mode for the next layer is different from the sparsity mode for the layer.

Example Computing Device

FIG. 19 is a block diagram of an example computing device 1900, in accordance with various embodiments. In some embodiments, the computing device 1900 can be used as at least part of the DNN system 300. A number of components are illustrated in FIG. 19 as included in the computing device 1900, but any one or more of these components may be omitted or duplicated, as suitable for the application. In some embodiments, some or all of the components included in the computing device 1900 may be attached to one or more motherboards. In some embodiments, some or all of these components are fabricated onto a single system on a chip (SoC) die. Additionally, in various embodiments, the computing device 1900 may not include one or more of the components illustrated in FIG. 19, but the computing device 1900 may include interface circuitry for coupling to the one or more components. For example, the computing device 1900 may not include a display device 1906, but may include display device interface circuitry (e.g., a connector and driver circuitry) to which a display device 1906 may be coupled. In another set of examples, the computing device 1900 may not include an audio input device 1918 or an audio output device 1908, but may include audio input or output device interface circuitry (e.g., connectors and supporting circuitry) to which an audio input device 1918 or audio output device 1908 may be coupled.

The computing device 1900 may include a processing device 1902 (e.g., one or more processing devices). The processing device 1902 processes electronic data from registers and/or memory to transform that electronic data into other electronic data that may be stored in registers and/or memory. The computing device 1900 may include a memory 1904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1904 may include memory that shares a die with the processing device 1902. In some embodiments, the memory 1904 includes one or more non-transitory computer-readable media storing instructions executable to perform operations for selecting sparsity modes (e.g., the method 1700 described in conjunction with FIG. 17), operations for accelerating DNN layers (e.g., the method 1800 described above in conjunction with FIG. 18), or some operations performed by the DNN system 300. The instructions stored in the one or more non-transitory computer-readable media may be executed by the processing device 1902.

In some embodiments, the computing device 1900 may include a communication chip 1912 (e.g., one or more communication chips). For example, the communication chip 1912 may be configured for managing wireless communications for the transfer of data to and from the computing device 1900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1912 may operate in accordance with other wireless protocols in other embodiments. The computing device 1900 may include an antenna 1922 to facilitate wireless communications and/or to receive other wireless communications (such as AM or FM radio transmissions).

In some embodiments, the communication chip 1912 may manage wired communications, such as electrical, optical, or any other suitable communication protocols (e.g., the Ethernet). As noted above, the communication chip 1912 may include multiple communication chips. For instance, a first communication chip 1912 may be dedicated to shorter-range wireless communications such as Wi-Fi or Bluetooth, and a second communication chip 1912 may be dedicated to longer-range wireless communications such as global positioning system (GPS), EDGE, GPRS, CDMA, WiMAX, LTE, EV-DO, or others. In some embodiments, a first communication chip 1912 may be dedicated to wireless communications, and a second communication chip 1912 may be dedicated to wired communications.

The computing device 1900 may include battery/power circuitry 1914. The battery/power circuitry 1914 may include one or more energy storage devices (e.g., batteries or capacitors) and/or circuitry for coupling components of the computing device 1900 to an energy source separate from the computing device 1900 (e.g., AC line power).

The computing device 1900 may include a display device 1906 (or corresponding interface circuitry, as discussed above). The display device 1906 may include any visual indicators, such as a heads-up display, a computer monitor, a projector, a touchscreen display, a liquid crystal display (LCD), a light-emitting diode display, or a flat panel display, for example.

The computing device 1900 may include an audio output device 1908 (or corresponding interface circuitry, as discussed above). The audio output device 1908 may include any device that generates an audible indicator, such as speakers, headsets, or earbuds, for example.

The computing device 1900 may include an audio input device 1918 (or corresponding interface circuitry, as discussed above). The audio input device 1918 may include any device that generates a signal representative of a sound, such as microphones, microphone arrays, or digital instruments (e.g., instruments having a musical instrument digital interface (MIDI) output).

The computing device 1900 may include a GPS device 1916 (or corresponding interface circuitry, as discussed above). The GPS device 1916 may be in communication with a satellite-based system and may receive a location of the computing device 1900, as known in the art.

The computing device 1900 may include another output device 1910 (or corresponding interface circuitry, as discussed above). Examples of the other output device 1910 may include an audio codec, a video codec, a printer, a wired or wireless transmitter for providing information to other devices, or an additional storage device.

The computing device 1900 may include another input device 1920 (or corresponding interface circuitry, as discussed above). Examples of the other input device 1920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1900 may be any other electronic device that processes data.

### SELECT EXAMPLES

The following paragraphs provide various examples of the embodiments disclosed herein.
Example 1 provides a method, including receiving a configuration parameter indicating whether to accelerate a layer in a neural network based on sparsity in a weight tensor of the layer; computing one or more activations of the layer in a previous layer in the neural network, in which the one or more activations are one or more elements of an activation tensor of the layer; determining an activation sparsity score of the layer, the activation sparsity score indicating a measurement of sparsity in the activation tensor; determining a sparsity mode for the layer based on the configuration parameter and the activation sparsity score; and performing one or more multiply-accumulate (MAC) operations of the layer in the sparsity mode.
Example 2 provides the method of example 1, in which performing the one or more MAC operations of the layer in the sparsity mode includes transferring data from a memory to one or more MAC units, the data selected based on the sparsity mode, in which the one or more MAC operations are performed by the one or more MAC units.
Example 3 provides the method of example 2, in which the memory stores: a compressed weight tensor and a weight sparsity tensor, the compressed weight tensor including one or more nonzero valued weights in the weight tensor, the weight sparsity tensor indicating one or more positions of the one or more nonzero valued weights in the weight tensor; and a compressed activation tensor and an activation sparsity tensor, the compressed activation tensor including one or more nonzero valued activations in the activation tensor, the activation sparsity tensor indicating one or more positions of the one or more nonzero valued activations in the activation tensor.
Example 4 provides the method of example 3, in which transferring the data includes selecting, based on the sparsity mode, the data from the compressed weight tensor, the weight sparsity tensor, the compressed activation tensor, and the activation sparsity tensor.
Example 5 provides the method of any one of examples 1-4, in which the configuration parameter indicates to accelerate the layer based on sparsity in the weight tensor, and the method further includes reading, from a memory, a compressed activation tensor and an activation sparsity tensor, the compressed activation tensor including one or more nonzero valued activations in the activation tensor, the activation sparsity tensor indicating one or more positions of the one or more nonzero valued activations in the activation tensor; and generating, using the activation sparsity tensor, the activation tensor by adding one or more zeros into the compressed activation tensor.
Example 6 provides the method of any one of examples 1-5, in which the configuration parameter indicates to accelerate the layer based on sparsity in the weight tensor, and the method further includes reading, from a memory, a compressed weight tensor and a weight sparsity tensor, the compressed weight tensor including one or more nonzero valued weights in the weight tensor, the weight sparsity tensor indicating one or more positions of the one or more nonzero valued weights in the weight tensor; and accelerating the layer by skipping one or more other MAC operations of the layer based on the weight sparsity tensor.
Example 7 provides the method of any one of examples 1-6, in which determining the sparsity mode includes determining whether the activation sparsity score is greater than a threshold score, the threshold score indicating an estimated reduction of power consumption for executing the layer by accelerating the layer based on sparsity in the activation tensor.
Example 8 provides the method of any one of examples 1-7, in which the configuration parameter is determined by: determining a weight sparsity score of the layer, the weight sparsity score indicating a measurement of sparsity in the weight tensor; and determining whether the weight sparsity score is greater than a threshold score, the threshold score indicating an estimated reduction of power consumption for executing the layer by accelerating the layer based on sparsity in the weight tensor.
Example 9 provides the method of any one of examples 1-8, in which the sparsity mode is selected from a two-sided sparsity mode, a one-sided weight sparsity mode, a one-sided activation sparsity mode, and a dense mode.
Example 10 provides the method of any one of examples 1-9, further including computing an activation tensor of a next layer in the neural network based on the one or more MAC operations; receiving an additional configuration parameter indicating whether to accelerate the next layer based on sparsity in a weight tensor of the next layer; determining an activation sparsity score of the next layer based on the activation tensor of the next layer; and determining a sparsity mode for the next layer based on the additional configuration parameter and the activation sparsity score of the next layer, in which the sparsity mode for the next layer is different from the sparsity mode for the layer.
Example 11 provides one or more non-transitory computer-readable media storing instructions executable to perform operations, the operations including receiving a configuration parameter indicating whether to accelerate a layer in a neural network based on sparsity in a weight tensor of the layer; computing one or more activations of the layer in a previous layer in the neural network, in which the one or more activations are one or more elements of an activation tensor of the layer; determining an activation sparsity score of the layer, the activation sparsity score indicating a measurement of sparsity in the activation tensor; determining a sparsity mode for the layer based on the configuration parameter and the activation sparsity score; and performing one or more multiply-accumulate (MAC) operations of the layer in the sparsity mode.
Example 12 provides the one or more non-transitory computer-readable media of example 11, in which performing the one or more MAC operations of the layer in the sparsity mode includes transferring data from a memory to one or more MAC units, the data selected based on the sparsity mode, in which the one or more MAC operations are performed by the one or more MAC units.
Example 13 provides the one or more non-transitory computer-readable media of example 12, in which the memory stores: a compressed weight tensor and a weight sparsity tensor, the compressed weight tensor including one or more nonzero valued weights in the weight tensor, the weight sparsity tensor indicating one or more positions of the one or more nonzero valued weights in the weight tensor; and a compressed activation tensor and an activation sparsity tensor, the compressed activation tensor including one or more nonzero valued activations in the activation tensor, the activation sparsity tensor indicating one or more positions of the one or more nonzero valued activations in the activation tensor.
Example 14 provides the one or more non-transitory computer-readable media of any one of examples 11-13, in which the configuration parameter indicates to accelerate the layer based on sparsity in the weight tensor, and the operations further include reading, from a memory, a compressed activation tensor and an activation sparsity tensor, the compressed activation tensor including one or more nonzero valued activations in the activation tensor, the activation sparsity tensor indicating one or more positions of the one or more nonzero valued activations in the activation tensor; and generating, using the activation sparsity tensor, the activation tensor by adding one or more zeros into the compressed activation tensor.
Example 15 provides the one or more non-transitory computer-readable media of any one of examples 11-14, in which the configuration parameter indicates to accelerate the layer based on sparsity in the weight tensor, and the operations further include reading, from a memory, a compressed weight tensor and a weight sparsity tensor, the compressed weight tensor including one or more nonzero valued weights in the weight tensor, the weight sparsity tensor indicating one or more positions of the one or more nonzero valued weights in the weight tensor; and accelerating the layer by skipping one or more other MAC operations of the layer based on the weight sparsity tensor.
Example 16 provides the one or more non-transitory computer-readable media of any one of examples 11-15, in which determining the sparsity mode includes determining whether the activation sparsity score is greater than a threshold score, the threshold score indicating an estimated reduction of power consumption for executing the layer by accelerating the layer based on sparsity in the activation tensor.
Example 17 provides the one or more non-transitory computer-readable media of any one of examples 11-16, in which the configuration parameter is determined by: determining a weight sparsity score of the layer, the weight sparsity score indicating a measurement of sparsity in the weight tensor; and determining whether the weight sparsity score is greater than a threshold score, the threshold score indicating an estimated reduction of power consumption for executing the layer by accelerating the layer based on sparsity in the weight tensor.
Example 18 provides an apparatus, including a computer processor for executing computer program instructions; and a non-transitory computer-readable memory storing computer program instructions executable by the computer processor to perform operations including receiving a configuration parameter indicating whether to accelerate a layer in a neural network based on sparsity in a weight tensor of the layer, computing one or more activations of the layer in a previous layer in the neural network, in which the one or more activations are one or more elements of an activation tensor of the layer, determining an activation sparsity score of the layer, the activation sparsity score indicating a measurement of sparsity in the activation tensor, determining a sparsity mode for the layer based on the configuration parameter and the activation sparsity score, and performing one or more multiply-accumulate (MAC) operations of the layer in the sparsity mode.
Example 19 provides the apparatus of example 18, in which performing the one or more MAC operations of the layer in the sparsity mode includes transferring data from a memory to one or more MAC units, the data selected based on the sparsity mode, in which the one or more MAC operations are performed by the one or more MAC units.
Example 20 provides the apparatus of example 18 or 19, in which: the configuration parameter is determined by: determining a weight sparsity score of the layer, the weight sparsity score indicating a measurement of sparsity in the weight tensor, and determining whether the weight sparsity score is greater than a threshold score, the threshold score indicating an estimated reduction of power consumption for executing the layer by accelerating the layer based on sparsity in the weight tensor, and determining the sparsity mode includes determining whether the activation sparsity score is greater than a threshold score, the threshold score indicating an estimated reduction of power consumption for executing the layer by accelerating the layer based on sparsity in the activation tensor.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method, comprising:
receiving a configuration parameter indicating whether to accelerate a layer in a neural network based on sparsity in a weight tensor of the layer;
computing one or more activations of the layer in a previous layer in the neural network, wherein the one or more activations are one or more elements of an activation tensor of the layer;
determining an activation sparsity score of the layer, the activation sparsity score indicating a measurement of sparsity in the activation tensor;
determining a sparsity mode for the layer based on the configuration parameter and the activation sparsity score; and
performing one or more multiply-accumulate (MAC) operations of the layer in the sparsity mode.

2. The method of claim 1, wherein performing the one or more MAC operations of the layer in the sparsity mode comprises:
transferring data from a memory to one or more MAC units, the data selected based on the sparsity mode, wherein the one or more MAC operations are performed by the one or more MAC units.

3. The method of claim 2, wherein the memory stores:
a compressed weight tensor and a weight sparsity tensor, the compressed weight tensor comprising one or more nonzero valued weights in the weight tensor, the weight sparsity tensor indicating one or more positions of the one or more nonzero valued weights in the weight tensor; and
a compressed activation tensor and an activation sparsity tensor, the compressed activation tensor comprising one or more nonzero valued activations in the activation tensor, the activation sparsity tensor indicating one or more positions of the one or more nonzero valued activations in the activation tensor.

4. The method of claim 3, wherein transferring the data comprises:
selecting, based on the sparsity mode, the data from the compressed weight tensor, the weight sparsity tensor, the compressed activation tensor, and the activation sparsity tensor.

5. The method of claim 1, wherein the configuration parameter indicates to accelerate the layer based on sparsity in the weight tensor, and the method further comprises:
reading, from a memory, a compressed activation tensor and an activation sparsity tensor, the compressed activation tensor comprising one or more nonzero valued activations in the activation tensor, the activation sparsity tensor indicating one or more positions of the one or more nonzero valued activations in the activation tensor; and
generating, using the activation sparsity tensor, the activation tensor by adding one or more zeros into the compressed activation tensor.

6. The method of claim 1, wherein the configuration parameter indicates to accelerate the layer based on sparsity in the weight tensor, and the method further comprises:
reading, from a memory, a compressed weight tensor and a weight sparsity tensor, the compressed weight tensor comprising one or more nonzero valued weights in the weight tensor, the weight sparsity tensor indicating one or more positions of the one or more nonzero valued weights in the weight tensor; and
accelerating the layer by skipping one or more other MAC operations of the layer based on the weight sparsity tensor.

7. The method of claim 1, wherein determining the sparsity mode comprises:
determining whether the activation sparsity score is greater than a threshold score, the threshold score indicating an estimated reduction of power consumption for executing the layer by accelerating the layer based on sparsity in the activation tensor.

8. The method of claim 1, wherein the configuration parameter is determined by:
determining a weight sparsity score of the layer, the weight sparsity score indicating a measurement of sparsity in the weight tensor; and
determining whether the weight sparsity score is greater than a threshold score, the threshold score indicating an estimated reduction of power consumption for executing the layer by accelerating the layer based on sparsity in the weight tensor.

9. The method of claim 1, wherein the sparsity mode is selected from a two-sided sparsity mode, a one-sided weight sparsity mode, a one-sided activation sparsity mode, and a dense mode.

10. The method of claim 1, further comprising:
computing an activation tensor of a next layer in the neural network based on the one or more MAC operations;
receiving an additional configuration parameter indicating whether to accelerate the next layer based on sparsity in a weight tensor of the next layer;
determining an activation sparsity score of the next layer based on the activation tensor of the next layer; and
determining a sparsity mode for the next layer based on the additional configuration parameter and the activation sparsity score of the next layer, wherein the sparsity mode for the next layer is different from the sparsity mode for the layer.

11. One or more non-transitory computer-readable media storing instructions executable to perform operations, the operations comprising:
receiving a configuration parameter indicating whether to accelerate a layer in a neural network based on sparsity in a weight tensor of the layer;
computing one or more activations of the layer in a previous layer in the neural network, wherein the one or more activations are one or more elements of an activation tensor of the layer;
determining an activation sparsity score of the layer, the activation sparsity score indicating a measurement of sparsity in the activation tensor;
determining a sparsity mode for the layer based on the configuration parameter and the activation sparsity score; and
performing one or more multiply-accumulate (MAC) operations of the layer in the sparsity mode.

12. The one or more non-transitory computer-readable media of claim 11, wherein performing the one or more MAC operations of the layer in the sparsity mode comprises:
transferring data from a memory to one or more MAC units, the data selected based on the sparsity mode, wherein the one or more MAC operations are performed by the one or more MAC units.

13. The one or more non-transitory computer-readable media of claim 12, wherein the memory stores:
a compressed weight tensor and a weight sparsity tensor, the compressed weight tensor comprising one or more nonzero valued weights in the weight tensor, the weight sparsity tensor indicating one or more positions of the one or more nonzero valued weights in the weight tensor; and
a compressed activation tensor and an activation sparsity tensor, the compressed activation tensor comprising one or more nonzero valued activations in the activation tensor, the activation sparsity tensor indicating one or more positions of the one or more nonzero valued activations in the activation tensor.

14. The one or more non-transitory computer-readable media of claim 11, wherein the configuration parameter indicates to accelerate the layer based on sparsity in the weight tensor, and the operations further comprise:
reading, from a memory, a compressed activation tensor and an activation sparsity tensor, the compressed activation tensor comprising one or more nonzero valued activations in the activation tensor, the activation sparsity tensor indicating one or more positions of the one or more nonzero valued activations in the activation tensor; and
generating, using the activation sparsity tensor, the activation tensor by adding one or more zeros into the compressed activation tensor.

15. The one or more non-transitory computer-readable media of claim 11, wherein the configuration parameter indicates to accelerate the layer based on sparsity in the weight tensor, and the operations further comprise:
reading, from a memory, a compressed weight tensor and a weight sparsity tensor, the compressed weight tensor comprising one or more nonzero valued weights in the weight tensor, the weight sparsity tensor indicating one or more positions of the one or more nonzero valued weights in the weight tensor; and
accelerating the layer by skipping one or more other MAC operations of the layer based on the weight sparsity tensor.

16. The one or more non-transitory computer-readable media of claim 11, wherein determining the sparsity mode comprises:
determining whether the activation sparsity score is greater than a threshold score, the threshold score indicating an estimated reduction of power consumption for executing the layer by accelerating the layer based on sparsity in the activation tensor.

17. The one or more non-transitory computer-readable media of claim 11, wherein the configuration parameter is determined by:
determining a weight sparsity score of the layer, the weight sparsity score indicating a measurement of sparsity in the weight tensor; and
determining whether the weight sparsity score is greater than a threshold score, the threshold score indicating an estimated reduction of power consumption for executing the layer by accelerating the layer based on sparsity in the weight tensor.

18. An apparatus, comprising:
a computer processor for executing computer program instructions; and
a non-transitory computer-readable memory storing computer program instructions executable by the computer processor to perform operations comprising:
receiving a configuration parameter indicating whether to accelerate a layer in a neural network based on sparsity in a weight tensor of the layer,
computing one or more activations of the layer in a previous layer in the neural network, wherein the one or more activations are one or more elements of an activation tensor of the layer,
determining an activation sparsity score of the layer, the activation sparsity score indicating a measurement of sparsity in the activation tensor,
determining a sparsity mode for the layer based on the configuration parameter and the activation sparsity score, and
performing one or more multiply-accumulate (MAC) operations of the layer in the sparsity mode.

19. The apparatus of claim 18, wherein performing the one or more MAC operations of the layer in the sparsity mode comprises:
transferring data from a memory to one or more MAC units, the data selected based on the sparsity mode,
wherein the one or more MAC operations are performed by the one or more MAC units.

20. The apparatus of claim 18, wherein:
the configuration parameter is determined by:
determining a weight sparsity score of the layer, the weight sparsity score indicating a measurement of sparsity in the weight tensor, and
determining whether the weight sparsity score is greater than a threshold score, the threshold score indicating an estimated reduction of power consumption for executing the layer by accelerating the layer based on sparsity in the weight tensor, and
determining the sparsity mode comprises determining whether the activation sparsity score is greater than a threshold score, the threshold score indicating an estimated reduction of power consumption for executing the layer by accelerating the layer based on sparsity in the activation tensor.
